(19) United States
(12) Patent Application Publication
(10) Pub. No.: US 2025/0162293 A1
(43) Pub. Date: May 22, 2025

(54) MULTILAYER FILM, PROCESS OF MAKING THE SAME, VACUUM PACKAGE AND PROCESS OF MAKING SAID PACKAGE

(71) Applicant: Cryovac, LLC, Charlotte, NC (US)

(72) Inventors: Roberto Forloni, Rho (MI) (IT); Henry Walker Stockley, III, Clover, SC (US)

(21) Appl. No.: 18/837,039

(22) PCT Filed: Feb. 8, 2023
(86) PCT No.: PCT/IB2023/051106

§ 371 Date: Aug. 8, 2024

(30) Foreign Application Priority Data
Feb. 9, 2022 (EP) 22155772.1

(51) Int. Cl. B32B 27/08; B29C 48/08; B29C 48/10; B29C 48/11; B29C 48/21; B29K 105/16; B29L 31/00; B32B 27/20; B65D 1/34; B65D 75/26; B65D 81/20

(52) U.S. Cl. CPC B32B 27/08; B29C 48/08; B29C 48/10; B29C 48/11; B29C 48/21; B32B 27/20; B65D 1/34; B65D 75/26; B65D 81/2023; B29K 2105/16; B29K 2995/0072; B29K 2995/0094; B29L 2031/712; B29L 2031/7128; B32B 2255/10; B32B 2264/20; B32B 2264/303; B32B 2307/31; B32B 2307/538; B32B 2307/73; B32B 2307/7376; B32B 2439/46; B32B 2439/70

(57) ABSTRACT

It is described a multilayer film for packaging, optionally for vacuum packaging, the multilayer film having a first external surface destined to contact a product hosted in the package and a second external surface opposite to the first external surface, wherein the multilayer film comprises a thermoplastic mono or multilayer base layer (B), a thermoplastic heat-scalable layer (A) adhered to the base layer (B), and microparticles incorporated in the heat-scalable layer (A) and in the mono or multilayer base layer (B); the microparticles are positioned and configured to confer to the first external surface of the multilayer film a Mean Roughness Depth (Rz) of at least 4.5 μm, measured according to ISO4287. A package and a process of packaging using the above multilayer film are also disclosed.

### FIELD OF THE INVENTION

The present invention relates to a multilayer film adapted for vacuum packaging and to a process of manufacturing said multilayer film. The invention also concerns packages, optionally vacuumized packages, optionally vacuum skin packages, for containing products, for example food products. The invention furthermore relates to a process and to an apparatus for manufacturing the mentioned vacuum packages using one or more of said multilayer films.

### Background Art

Plastic films are widely used, optionally in the food industry, to form packages. For example plastic films are used to wrap a product or to form a bag into which the product is inserted or for closing a tray hosting the product.

Plastic films are designed in order to present specific technical effects functional to the type of package or product to be packaged.

For example, in certain applications it may be desirable to reduce adhesion of the product to the inner surface of the package. In this respect, documents EP2397319B1 and EP2857190B1 (Toyo) describe multilayer packaging lid films designed for low adherence to the packaged products: these films have a sealant layer coated on the outermost surface with hydrophobic oxide nanoparticles. Again in order to facilitate extraction of fluids from packages, WO2020/025148A1 discloses packages made from multilayer thermoplastic films having hydrophobic coating on the surface of the film.

In other contexts, it may be desirable to achieve an effective and quick vacuumization of the package, minimizing the quantity of air remaining trapped inside the package. In this respect, U.S. Pat. No. 7,022,058 B2 discloses thermal/mechanically embossed films to create channels or a dimpled surface on a polymeric film such that, when the two panels of the bag/pouch collapse under vacuum pressure from the nozzle, the one embossed panel allows the air to be drawn towards the vacuum nozzle or vacuum source at the open end of the bag/pouch. This facilitates removal of the air from the bottom end of the bag and from around the food product or item being vacuum packaged. Although extensively used, the solution disclosed in U.S. Pat. No. 7,022,058 B2 presents several drawbacks: in fact embossing thin multilayer films requires temperature controlled calenders, with related purchase and operation costs. Moreover, embossing represents an additional operation in the manufacturing process of the film, which thus inevitably increases manufacturing costs and process complexity. Furthermore, embossing thin films may damage the film or alter the film properties.

### OBJECT OF THE INVENTION

The object of the present invention is to solve the drawbacks and/or limitations of the above prior art. A first object of the invention is to provide a multilayer film for packages, optionally for vacuum packages designed to confer to the package enhanced ability to be emptied from its content or vacuumized.

Furthermore, it is an object of the present invention to provide a multilayer film and a related package which can be manufactured without requiring additional expensive steps or specific tools compared to conventional films and packages.

A further object of the present invention is to provide a package guaranteeing a strong seal and a robust packaging.

Another object of the invention is a package of simple and cost-effective structure.

An additional object is that of offering a package suitable of improved aesthetics.

A yet further object is to provide a process for effectively making the mentioned film, package and related packaged product.

Finally, it is an object of the invention providing a multilayer film structure and a related manufacturing process, which may be implemented even in case of thin films such as those for packaging, with no risk of damaging the film or altering the film properties during manufacture.

These and other objects, which will become more apparent from the following description, are substantially achieved by a multilayer film and related manufacturing process, and by a package and a related packaging process according to one or more of the accompanying claims and/or the following aspects.

### SUMMARY

One or more of the above objects are substantially achieved by a packaging multilayer film and/or by a film manufacturing process according to any one of the corresponding aspects herewith enclosed. One or more of the above objects are also attained by a packaging article, a package and packaging processes according to one or more of the accompanying aspects.

Aspects of the invention are disclosed below.

A 1^{st} aspect concerns a multilayer film for packaging, optionally for vacuum packaging, the multilayer film having a first external surface destined to contact a product hosted in a package and a second external surface opposite to the first external surface, wherein the multilayer film comprises:
a thermoplastic mono or multilayer base layer (B),
a thermoplastic heat-sealable layer (A) adhered to the base layer (B),
microparticles at least in part incorporated in at least one of said heat-sealable layer (A) and said mono or multilayer base layer (B).

In a 2^{nd} aspect according to the 1^{st} aspect one or more regions of said first external surface of the multilayer film present a Mean Roughness Depth (Rz) of at least 4.5 μm, measured according to ISO4287.

In a 3^{rd} aspect according to any one of the preceding aspects the entire first external surface of the multilayer film has a Mean Roughness Depth (Rz) of at least 4.5 μm, measured according to ISO4287.

In a 4^{th} aspect according to any one of the preceding aspects one or more regions of said first external surface of the multilayer film present a Mean Roughness Depth (Rz) of at least 5.0 μm, measured according to ISO4287; or
the entire first external surface of the multilayer film presents a Mean Roughness Depth (Rz) of at least 5.0 μm, measured according to ISO4287.

In a 5^{th} aspect according to any one of the preceding aspects wherein the microparticles are spherical or spheroid or ovoid or teardrop shaped microparticles, or wherein the microparticles are non-hollow spherical or spheroid or ovoid or teardrop shaped microparticles.

In a 6^{th} aspect according to any one of the preceding aspects the microparticles have an average particle diameter from 10 μm to 110 μm, optionally approximately from 20 μm to 100 μm, more optionally approximately from 30 μm to 90 μm.

In a 7^{th} aspect according to any one of the preceding aspects the microparticles present a particle volume from 5.2·10² μm³ to 7.0·10⁵ μm³, optionally approximately from 4.1·10³ μm³ to 5.2·10⁵ μm³, more optionally approximately from 1.4·10⁴ μm³ to 3.8·10⁵ μm³.

In an 8^{th} aspect according to any one of the preceding aspects the microparticles are incorporated in the heat-sealable layer (A), each of said microparticles being entirely embedded in thermoplastic material forming the heat-sealable layer (A).

In a 9^{th} aspect according to any one of the preceding aspects the microparticles are incorporated in the thermoplastic mono or multilayer base layer (B), each of said microparticles being entirely embedded in thermoplastic material forming the mono or multilayer base layer (B).

In a 10^{th} aspect according to any one of the preceding aspects the microparticles in said heat-sealable layer (A) are in amount of at least 5% by weight calculated in respect of the total weight of said heat-sealable layer (A).

In an 11^{th} aspect according to the preceding aspect the microparticles in the heat-sealable layer (A) are in amount which is:
from 5% to 60% by weight calculated in respect of the total weight of said heat-sealable layer (A), or
from 15% to 55% by weight calculated in respect of the total weight of said heat-sealable layer (A), or
from 25% to 50% by weight calculated in respect of the total weight of said heat-sealable layer (A)

In a 12^{th} aspect according to any one of the preceding aspects the mono or multilayer base layer (B) comprises no microparticles or microparticles in amount lower than 1% by weight calculated in respect of the total weight of said mono or multilayer base layer (B).

In a 13^{th} aspect according to any one of the preceding aspects from 1 to 11 the microparticles in the mono or multilayer base layer (B) are in amount of at least 5% by weight calculated in respect of the total weight of said mono or multilayer base layer (B).

In a 14^{th} aspect according to the preceding aspect the microparticles in the mono or multilayer base layer (B) are in amount which is:
from 5% to 60% by weight calculated in respect of the total weight of said mono or multilayer base layer (B), or
from 15% to 55% by weight calculated in respect of the total weight of said mono or multilayer base layer (B), or
from 25% to 50% by weight calculated in respect of the total weight of said of said mono or multilayer base layer (B).

In a 15^{th} aspect according to any one of the 12th or 13th or 14th aspect when depending upon any one of the preceding aspects from 1 to 9, wherein the heat-sealable layer (A) comprises no microparticles or microparticles in amount lower than 1% by weight calculated in respect of the total weight of said heat-sealable layer (A).

In a 16^{th} aspect according to any one of the preceding aspects the heat-sealable layer (A) has a free and not further coated surface, opposed to the mono or multilayer base layer (B), defining said first external surface destined to contact the product.

In a 17^{th} aspect according to any one of the preceding aspects the heat sealable layer (A) has an average thickness from 1 μm to 30 μm, optionally from 2 μm to 20 μm, and
the mono or multilayer base layer (B) consists of or comprises a support layer (b) directly adhered to the heat sealable layer (A), or adhered to the heat sealable layer (A) via interposition of a tie layer, wherein the support layer (b) has average thickness from 3 μm to 80 μm, optionally from 20 μm to 70 μm.

In a 18^{th} aspect according to any one of the preceding aspects the microparticles have a particle size, optionally an average particle diameter, of at least 20%, optionally at least 30%, more optionally at least 50%, greater than the average thickness of the layer of the film in which the microparticles are incorporated.

In a 19^{th} aspect according to any one of the preceding aspects the heat sealable layer (A) has an average thickness smaller than 10 μm, optionally from 1 μm to 5 μm.

In a 20^{th} aspect according to any one of the preceding aspects with the exception of the microparticles, the multilayer film consists of one or more thermoplastic materials, and
wherein the multilayer film has a total thickness from 5 μm to 250 μm, optionally from 10 μm to 200 μm.

In a 21^{st} aspect according to any one of the preceding aspects the heat-sealable layer (A) comprises a major amount of a polymer selected among ethylene-vinyl acetate copolymers (EVA), polyethylenes, homogeneous or heterogeneous linear ethylene-alpha-olefin copolymers, polypropylene copolymers (PP), ethylene-propylene copolymers (EPC), acrylates, methacrylates, ionomers, polyesters, polyamides and their blends.

In a 22^{nd} aspect according to any one of the preceding aspects the base layer (B) is monolayer (b); or the base layer (B) is multilayer having a/the support layer (b) directly adhered to the heat-sealable layer (A), only said support layer incorporating the microparticles.

In a 23^{rd} aspect according to any one of the preceding aspects the thermoplastic base layer (B) is monolayer and consists of a support layer (b), or is a multilayer (B) and comprises a support layer (b) directly adhered to the heat sealable layer (A).

In a sub aspect of this aspect said support layer (b) has a major proportion of, optionally consisting of, one or more thermoplastic resins selected from polyethylenes, polypropylenes, ethylene vinyl acetates (EVAs), ionomers, polyamides, polyesters, optionally blended with adhesive resins.

In a 24^{th} aspect according to any one of the preceding aspects the base layer (B) is multilayer and comprises one or more inner layers selected among an inner gas barrier layer (8), an inner bulk layer, an inner tie layer and/or an outer anti-abuse layer.

In a 25^{th} aspect according to any one of the preceding aspects the microparticles are at least one among acrylic microparticles, silica microparticles, boron silicate microparticles, calcium phosphate microparticles, calcium stearate microparticles, glass microparticles and charcoal powders.

In a 26^{th} aspect according to any one of the preceding aspects the thermoplastic heat sealable layer (A) and at least a/the support layer (b) of the thermoplastic mono or multilayer base layer (B) directly adhered to layer (A) are obtained by a co-extrusion process, wherein the microparticles are embedded into one or both the support layer (b) of the thermoplastic base layer (B) and the heat sealable layer (A) during the co-extrusion process.

In a 27^{th} aspect according to any one of the preceding aspects said second external surface is smooth or presents a Mean Roughness Depth (Rz) lower than 1.5 μm, measured according to ISO4287.

In a 28^{th} aspect according to any one of the preceding aspects said one or more regions of said first external surface, optionally the entire first external surface, of the multilayer film are patterned surface regions comprising:
a substantially smooth base surface in areas where the first external surface has no underlying microparticles, and
micro-protrusions emerging with respect to the smooth base surface where the first surface has underlying microparticles,

wherein the distance between crests of said micro-protrusions and the smooth base surface is comprised between 30 μm and 100 μm, optionally between 40 μm and 80 μm.

In a 29^{th} aspect according to any one of the preceding aspects from 1 to 15 and from 17 to 28, wherein the surface of the heat-sealable layer (A) not directly adhered to the base layer (B) is coated with a hydrophobic or super-hydrophobic layer (C).

In a 30^{th} aspect according to the preceding aspect the super-hydrophobic layer (C) is made from an inorganic composition comprising hydrophobic oxide nanoparticles having an average particle diameter from 3 nm to 100 nm.

A 31^{st} aspect concerns a process of manufacturing the multilayer film according to any one of the preceding aspects comprising coextruding at least the thermoplastic heat-sealable layer (A) with the thermoplastic monolayer (B) or with at least the/a support layer (b) of the multilayer base layer (B) directly adhered to the heat-sealable layer (A).

In a 32^{nd} aspect according to the preceding aspect the thermoplastic heat-sealable layer (A) is co-extruded with all layers of the multilayer base layer (B).

In a 33^{rd} aspect according to the 31^{st} or 32^{nd} aspect the thermoplastic heat-sealable layer (A) is co-extruded with the thermoplastic monolayer (b) or with at least the support layer of the multilayer base layer (B) directly adhered to layer (A) using either a round or a flat die respectively shaping the polymer melt into a tubular or a flat film.

In a 34^{th} aspect according to any one of the preceding aspects from 30 to 32 the microparticles are mixed with the thermoplastic polymer(s) used for extrusion of the monolayer (B) or of the support layer (b) of multilayer base layer (B) directly adhered to heat-sealable layer (A); and/or
the microparticles are mixed with the thermoplastic polymer(s) used for extrusion of the heat-sealable layer (A).

In a 35^{th} aspect according to the preceding aspect the microparticles are compounded with a carrier resin to give a masterbatch which is then extruded with thermoplastic polymer(s) used for the monolayer (b) or the support layer of multilayer base layer (B) directly adhered to layer (A), and/or the microparticles are compounded with a carrier resin to give a masterbatch which is then extruded with thermoplastic polymer(s) used for the heat-sealable layer (A).

In a 35bis aspect according to the 34^{th} aspect the microparticles are dry blended with the respective thermoplastic polymer(s) forming the monolayer (B) or the support layer of multilayer base layer (B) directly adhered to layer (A) directly in extrusion, without previous compounding, and/or the microparticles are dry blended with the respective thermoplastic polymer(s) forming the heat-sealable layer (A) directly in extrusion, without previous compounding.

A 36^{th} aspect concerns an article for packaging comprising at least one multilayer film of any one of aspects from 1 to 30 or obtained using the process of any one of aspects from 31 to 35, wherein the multilayer film is configured to define or cooperate to define a volume, in particular an inner volume, destined to receive at least one product,
wherein said first external surface of the multilayer film directly faces the volume, in particular the inner volume.

In a 37^{th} aspect according to the preceding aspect the article has at least one opening for introducing a product, optionally a food product, into the volume, optionally into one or more seats or spaces of the inner volume.

In a 38^{th} aspect according to the 35^{th} or 36^{th} aspect the article is in a form selected among the following options:
a) a seamless tubing obtained by manufacturing, optionally by coextruding, the multilayer film directly in tubular form, with said first external surface of the multilayer film directly facing the inner volume inside the seamless tubing, or
b) a longitudinally sealed tubing obtained from the multilayer film which is shaped in tubular form with opposed longitudinal borders of the multilayer film sealed, optionally heat sealed, to each other to form the tubing, with said first external surface of the multilayer film directly facing the inner volume inside the longitudinally sealed tubing, or
c) an almost tubular film structure obtained from the multilayer film which is shaped in a substantially tubular form with opposed longitudinal borders of the multilayer film approached to each other to form a longitudinal opening extending along the almost tubular film structure, with said first external surface of the multilayer film directly facing the inner volume inside the almost tubular film structure, or
d) a flexible container formed from or comprising the multilayer film, in the form of a pouch or a bag, with said first external surface of the multilayer film directly facing the inner volume of the pouch or bag, or
e) a tray comprising or formed from the multilayer film, optionally obtained by thermoforming the multilayer film, with said first external surface of the multilayer film forming part or the entirety of a top surface of the tray destined to delimit said volume, or
f) a plurality of interconnected trays comprising or formed from the multilayer film, optionally obtained by thermoforming the multilayer film, with said first external surface of the multilayer film forming part or the entirety of a top surface of the plurality of interconnected trays destined to delimit respective volumes, or
g) a tray with a closure film, wherein the tray comprises or is formed from the multilayer film, with said first external surface of the multilayer film forming part or the entirety of a top surface of the tray destined to be sealed to a bottom surface of the closure film, or
h) a tray with a closure film, wherein the closure film comprises or is formed from the multilayer film, with said first external surface of the multilayer film forming a part or the entirety of a bottom surface of the closure film destined to be sealed to a top surface of the one or more trays, or
i) a tray with a closure film, wherein
   the tray comprises or is formed from a first multilayer film according to the preceding aspects from 1 to 30 or obtained using the process of any one of the preceding aspects from 31 to 35, and
   the closure film comprises or is formed from a second multilayer film according to the preceding aspects from 1 to 30 or obtained using the process of any one of the preceding aspects from 31 to 35,
   the first external surface of the first multilayer film forms part or the entirety of a top surface of the tray destined to be sealed to a bottom surface of the closure film, and
   the first external surface of the second multilayer film forms part or the entirety of the bottom surface of the closure film destined to be sealed to the top surface of the tray.

In a 38^{th} bis aspect according to the 38^{th} aspect, the article for packaging is in the form of a pouch or a bag formed from or comprising the multilayer film, with said first external surface of the multilayer film directly facing the inner volume of the pouch or bag, said pouch or bag being equipped with a spout or an accommodation for inserting a straw.

A 39^{th} aspect concerns a vacuum package comprising:
at least one portion of:
   the multilayer film of any one of the preceding aspects from 1 to 30, or
   the multilayer film obtained with the process of any one of the preceding aspects from 31 to 35,
   the article for packaging of any one of the preceding aspects from 34 to 36, and
a product, optionally a food product,
wherein the package is vacuumized and hermetically sealed, optionally heat sealed, with at least a portion of the first external surface of said multilayer film or article for packaging contacting the product housed inside the package.

In a 40^{th} aspect according to the preceding aspect the vacuum package comprises one or more seats or spaces, wherein the product is housed in each one of said one or more seats or spaces, wherein said one or more seats or spaces are vacuumized and hermetically sealed, optionally heat sealed, with said at least a portion of the first external surface of the multilayer film contacting the product.

In a 41^{st} aspect according to the 38^{th} or 39^{th} aspect the package is a vacuum skin package, and wherein the multilayer film forms a skin on at least a portion of an external surface of the product, optionally on the entire product external surface.

In a 42^{nd} aspect according to the 39^{th} or 40^{th} or 41^{st} aspect the vacuum package is in the form of a bag or pouch entirely formed by a single multilayer film, wherein said first external surface of the multilayer film:
forms at least a portion, optionally the entirety, of the inner surface of the bag or pouch delimiting one or more spaces, and
is in contact with the product housed in the one or more spaces and/or with the first external surface of the same multilayer film.

In a 43^{rd} aspect according to the 39^{th} or 40^{th} or 41^{st} aspect the vacuum package is in the form of a bag or pouch comprising or consisting of two or more films coupled together, optionally heat sealed together, to form said bag or pouch, wherein at least one of the two or more films is a multilayer film according to any one of the preceding aspects from 1 to 30 and wherein the first external surface of said at least one multilayer film:
forms at least a portion of the inner surface of the bag or pouch, optionally the entirety, of the inner surface of the bag or pouch delimiting one or more spaces, and
is in contact with the product housed in the one or more spaces and/or with the first external surface of the same multilayer film or with the surface of another of said the two or more films.

In a 44^{th} aspect according to the 42^{nd} or 43^{rd} aspect one or more spaces inside the pouch or bag contain a treatment gas different from air.

In a 45^{th} aspect according to the 39^{th} or 40^{th} or 41^{st} aspect the vacuum package comprises a tray, which is either a flat tray or a tray with a base wall and a side wall emerging from the base wall, wherein:
the tray comprises said multilayer film, whose first external surface forms the top surface of the tray,
the product is placed on the tray top surface in contact with the said first external surface of the multilayer film, and
a top film is sealed to top surface of the tray to form with the tray a hermetically sealed package,
optionally the top film forming a skin on part of the product surface and on a portion of the tray top surface not occupied by the product.

In a 46^{th} aspect according to the 39^{th} or 40^{th} or 41^{st} aspect the vacuum package comprises a tray, which is either a flat tray or a tray with a base wall and a side wall emerging from the base wall, wherein:
the product is placed on a tray top surface in contact with the said first external surface of the first multilayer film, and
a top film formed by said multilayer film is sealed to the top surface of the tray to form with the tray a hermetically sealed package, with the first external surface of the multilayer film facing inside said package,
optionally with the first external surface of the multilayer film being in contact with the product and with at least a portion of the tray top surface not occupied by the product, the top film forming a skin on part of the product surface and on said portion of the tray top surface not occupied by the product.

In a 47^{th} aspect according to the 39^{th} or 40^{th} or 41^{st} aspect the vacuum package comprises a tray, which is either a flat tray or a tray with a base wall and a side wall emerging from the base wall, wherein:
the tray is formed by a first of said multilayer films, with the first external surface of the first multilayer film forming the top surface of the tray receiving the product,
the product is placed on the tray top surface in contact with the said first external surface of the first multilayer film, and
a top film formed by a second of said multilayer films is sealed to the top surface of the tray to form with the tray a hermetically sealed package, with the first external surface of the second multilayer film facing inside said package,
optionally with the first external surface of the second multilayer film being in contact with the product and with at least a portion of the tray top surface not occupied by the product, the top film forming a skin on part of the product surface and on said portion of the tray top surface not occupied by the product.

A 48^{th} aspect concerns a packaging process comprising:
providing one or more products to be packaged, optionally food products,
providing an article for packaging according to any one of the preceding aspects from 36 to 38, such that the one or more products are located inside the inner volume of said article for packaging,
evacuating gas from the inner volume of the article for packaging wherein, during gas evacuation, a portion of the first external surface of the at least one multilayer film adheres to a product surface leaving micro-passages between said first external surface and the product surface,
after having completed the gas evacuation step, hermetically sealing, optionally heat sealing, portions of said article for packaging and forming one or more vacuum packaged products.

A 49^{th} aspect concerns a packaging process comprising:
providing one or more products to be packaged, optionally food products,
configuring at least one multilayer film according to any one of the preceding aspects from 1 to 30 to form or cooperate to form at least one inner volume, such that the one or more products are located inside the at least one inner volume,
evacuating gas from the at least one inner volume wherein, during gas evacuation, a portion of the first external surface of the at least one multilayer film adheres to a product surface leaving micro-passages between said first external surface and the product surface facilitating gas evacuation,
after having completed the gas evacuation step, hermetically sealing, optionally heat sealing, portions of said multilayer film and forming one or more vacuum packaged products.

In a 50^{th} aspect according to the 48^{th} or 49^{th} aspect during gas evacuation, the at least one multilayer film is draped down onto the product and forms a vacuum skin package.

In a 51^{st} aspect according to any one of the preceding aspects from 48 to 50 sealing comprises:
a) heat sealing to each other one or more seal bands of a same multilayer film of the preceding aspects from 1 to 30 to form a bag or pouch package, or
b) heat sealing one or more seal bands of a first multilayer film according to the preceding aspects from 1 to 30 with one or more seal bands of a second multilayer film according to the preceding aspects from 1 to 30 to form a bag or pouch package, or
c) heat sealing one or more seal bands of a multilayer film of the preceding aspects from 1 to 30 and one or more seal bands of a further film to form a bag or pouch package, or
d) heat sealing one or more seal bands of a multilayer film of the preceding aspects from 1 to 30 and one or more seal bands of a tray, optionally the one or more tray seal bands extending at a flange of the tray to form a sealed tray package, or
e) heat sealing one or more seal bands of a tray obtained from a multilayer film of the preceding aspects from 1 to 30, the one or more tray seal bands optionally extending at a flange of the tray, with one or more seal bands of a further film to form a sealed tray package,
f) heat sealing one or more seal bands of a tray obtained from a multilayer film of the preceding aspects from 1 to 30, the tray seal bands optionally extending at a flange of the tray, with one or more seal bands of a further multilayer film of the preceding aspects from 1 to 30 to form a sealed tray package.

In a 52^{nd} aspect according to the preceding aspect wherein:
under alternative a), before heat sealing said one or more seal bands, one or more portions of the first external surface of the multilayer film are brought into intimate contact with one or more other portions of the first external surface of the same multilayer film, yet leaving micro-passages therebetween facilitating gas evacuation,
under alternative b), before heat sealing said one or more seal bands, one or more portions of the first external surface of the first multilayer film are brought into intimate contact with one or more portions of the first external surface of the second multilayer film, yet leaving micro-passages therebetween facilitating gas evacuation,
under alternative c), before heat sealing said one or more seal bands, one or more portions of the first external surface of the multilayer film are brought into intimate contact with one or more portions of an external surface of the further film, yet leaving micro-passages therebetween facilitating gas evacuation,
under alternative d), before heat sealing said one or more seal bands, one or more portions of the first external surface of the multilayer film are brought into intimate contact with one or more portions of an external surface of the tray, yet leaving micro-passages therebetween facilitating gas evacuation,
under alternative e), before heat sealing said one or more seal bands, one or more portions of the first external surface of multilayer film forming the tray are brought into intimate contact with one or more portions of an external surface of the further film, yet leaving micro-passages therebetween facilitating gas evacuation,
under alternative f), before heat sealing said one or more seal bands, one or more portions of the first external surface of the multilayer film forming the tray are brought into intimate contact with one or more portions of the first external surface of the further multilayer, yet leaving micro-passages therebetween facilitating gas evacuation.

In a 53^{rd} aspect according to the 51^{st} or 52^{nd} aspect once the gas evacuation step is complete and before sealing, in particular before heat sealing, a treatment gas is back-filled into the pouch or bag or tray package,
optionally wherein the treatment gas does not contain oxygen such that residual oxygen level inside the bag or pouch or tray package is reduced upon back-filling.

A 54^{th} aspect concerns a packaging process comprising the following steps:
advancing along a predetermined path, optionally along predetermined vertical or horizontal path, the article for packaging in the form of the seamless tubing of aspect 38, option a) or in the form of the longitudinally sealed tubing of aspect 38, option b),
forming a transversal seal, optionally a transversal heat seal, across the seamless tubing or longitudinally sealed tubing to define at least one seat or space, the seat or space receiving a respective product therein, optionally a food product, and presenting an opening, optionally an open end,
evacuating gas from the seat or space via the opening,
hermetically closing the evacuated open seat or space and forming a vacuumized closed package;
   optionally wherein hermetically closing the evacuated open seat comprises forming a further transversal seal, more optionally a further transversal heat seal, spaced from the transversal seal and extending across the seamless tubing or the longitudinally sealed tubing, wherein the further transversal seal hermetically closes the evacuated open seat or space and forms a closed package extending between the transversal seal and the further transversal seal and housing said product,
cyclically repeating the above steps to form a plurality of closed packages,
optionally separating the packages from one another.

In a 54bis aspect according to the preceding aspect, the packaging process is according to any one of the preceding aspects from 48 to 53.

A 55^{th} aspect concerns a packaging process comprising the following steps:
advancing along a predetermined path, optionally along a predetermined vertical or horizontal path, the article for packaging in the form of the almost tubular film structure of aspect 38, option c),
hermetically sealing said longitudinal opening, optionally hermetically heat sealing said longitudinal opening, forming a longitudinally sealed tubing,
forming a transversal seal, optionally a transversal heat seal, across the longitudinally sealed tubing to define at least one seat or space, the seat or space receiving a respective product therein, optionally a food product, located therein and presenting and presenting an opening, optionally an open end,
evacuating gas from the seat or space via the opening,
hermetically closing the evacuated open seat or space and forming a vacuumized closed package;
   optionally wherein hermetically closing the evacuated open seat comprises forming a further transversal seal, more optionally a further transversal heat seal, spaced from the transversal seal and extending across the seamless tubing or the longitudinally sealed tubing, wherein the further transversal seal hermetically closes the evacuated open seat or space and forms a closed package extending between the transversal seal and the further transversal seal and housing said product,
cyclically repeating the above steps to form a plurality of closed packages,
optionally separating the packages from one another.

In a 55bis aspect according to the preceding aspect, the packaging process is according to any one of the preceding aspects from 48 to 53.

A 56^{th} aspect concerns a packaging process comprising the following steps:
advancing along a predetermined path, optionally along predetermined vertical or horizontal path, a multilayer film according to any one of the preceding aspects from 1 to 30,
configuring the multilayer film in a substantially tubular form with opposed longitudinal borders of the multilayer film approached to each other defining a longitudinal opening extending along the almost tubular film structure, with said first external surface of the multilayer film directly facing the inner volume inside the almost tubular film structure,
hermetically sealing said longitudinal opening, optionally hermetically heat sealing said longitudinal opening, forming a longitudinally sealed tubing,
forming a transversal seal, optionally a transversal heat seal, across the longitudinally sealed tubing to define at least one seat or space, the seat or space receiving a respective product therein, optionally a food product, located therein and presenting and presenting an opening, optionally an open end,
evacuating gas from the seat or space via the opening,
hermetically closing the evacuated open seat or space and forming a vacuumized closed package;
   optionally wherein hermetically closing the evacuated open seat comprises forming a further transversal seal, more optionally a further transversal heat seal, spaced from the transversal seal and extending across the seamless tubing or the longitudinally sealed tubing, wherein the further transversal seal hermetically closes the evacuated open seat or space and forms a closed package extending between the transversal seal and the further transversal seal and housing said product,
cyclically repeating the above steps to form a plurality of closed packages,
optionally separating the packages from one another.

In a 56bis aspect according to the preceding aspect, the packaging process is according to any one of the preceding aspects from 48 to 53.

In a 57^{th} aspect according to the 54^{th} or 55^{th} or 56^{th} aspect or according to aspect 54bis or 55bis or 56bis, the step of evacuating gas comprises:
positioning at least one nozzle at the opening, optionally at the open end, or inside said seat or space,
withdrawing gas from said seat or space through said at least one nozzle.

In a 58^{th} aspect according to any one of the preceding aspects 54 or 55 or 56 or 54bis or 55bis or 56bis or 57 once the gas evacuation step is complete and before sealing, in particular before heat sealing, a treatment gas is back-filled into said seat or space, through the same nozzle used for gas evacuation or through a distinct nozzle.

In a 59^{th} aspect according to the preceding aspect the treatment gas does not contain oxygen such that residual oxygen level inside the seat or space is reduced upon back-filling.

In a 60^{th} aspect according to the 57^{th} or 58^{th} or 59^{th} aspect the at least one nozzle, or each one of the nozzle and the distinct nozzle, comprises a respective external nozzle surface and one or more suction/injection apertures defined at said external nozzle surface; and
wherein during the step of evacuating gas or back-filling treatment gas, the first external surface of the multilayer film or of the article contacts the external surface of the at least one nozzle, or of each one of the nozzle and the distinct nozzle, yet leaving micro-passages between said first external surface and the external nozzle surface facilitating gas evacuation/injection via said suction/injection apertures.

In a 61^{st} aspect according to any one of the preceding aspects from 57 to 60 the nozzle, or each one of the nozzle and the distinct nozzle, comprises a terminal large and thin portion having a thickness sensibly smaller than its width configured for insertion in a seat or space of flat packages.

A 62^{nd} aspect concerns a packaging process comprising the following steps:
advancing along a predetermined path, optionally a predetermined vertical or horizontal path, an article for packaging in the form of the almost tubular film structure of aspect 38, option c),
forming transversal seals, optionally transversal heat seals, across the almost tubular film structure to define consecutive seats or spaces, with each seat or space provided with an open side and a product, optionally a food product, located in the seat or space,
inserting open sides of each seat or space in a vacuum chamber positioned along or parallel to said predetermined path, while keeping the part of each seat or space housing the product outside the vacuum chamber,
evacuating gas from the seats or spaces via the open sides inserted inside said vacuum chamber,
forming a longitudinal seal, optionally a longitudinal heat seal, hermetically closing the open sides of the evacuated seats or spaces and forming closed packages extending between consecutive transversal seals,
optionally separating the packages from one another.

In a 62bis aspect according to the preceding aspect, the packaging process is according to any one of the preceding aspects from 48 to 53.

A 63^{rd} aspect concerns a packaging process comprising the following steps:
providing a flexible container comprising the multilayer film of any one of the preceding aspects from 1 to 30 in the form of a pouch or a bag with said first external surface of the multilayer film directly facing the inner volume of the pouch or bag, or providing an article for packaging according to aspect 38, option d),
placing one or more products, optionally food products, inside the pouch or bag,
inserting an open end of the flexible container inside a vacuum chamber, while keeping a part of each flexible container housing the product outside the vacuum chamber,
evacuating gas from the inner volume of the flexible container,
forming a seal, optionally a heat seal, hermetically closing the open end of the evacuated flexible container thus forming one or more vacuum packages.

In a 63bis aspect according to the preceding aspect, the packaging process is according to any one of the preceding aspects from 48 to 53.

A 64^{th} aspect concerns a packaging process comprising the following steps:
providing a flexible container comprising the multilayer film of any one of the preceding aspects from 1 to 30 in the form of a pouch or a bag with said first external surface of the multilayer film directly facing the inner volume of the pouch or bag, or providing an article for packaging according to aspect 38, option d),
placing one or more products, optionally food products, inside the pouch or bag,
inserting a part of the flexible container housing the product inside a first part of a vacuum chamber,
inserting an open end of the flexible container inside a second part of the vacuum chamber adjacent to the first part of the vacuum chamber,
controlling gas pressure in the first part and in the second part of the vacuum chamber to determine gas evacuation from the inner volume of the flexible container through the open end,
forming a seal, optionally a heat seal, hermetically closing the open end of the evacuated flexible container thus forming one or more vacuum packages.

In a 64bis aspect according to the preceding aspect, the packaging process is according to any one of the preceding aspects from 48 to 53.

A 65^{th} aspect concerns a packaging process comprising the following steps:
advancing a bottom film along a predetermined path, wherein a thermoforming station and a packaging station are operative along said operating path,
receiving said bottom film at the thermoforming station and forming tray shaped elements in the bottom film, wherein each tray shaped element defines at least one respective seat for receiving a product,
positioning at least one respective product in each one of the seats of the tray shaped elements,
advancing a top film towards the packaging station,
receiving at the at the packaging station consecutive portions of the top film and of the bottom film,
at the packaging station:
   aligning a portion of the top film above a corresponding portion of the bottom film having one or more tray shaped elements,
   evacuating gas present in a volume between said aligned portions of the top film and of the bottom film,
   sealing, optionally heat sealing, the said aligned portions of the top film and of the bottom film to form one or more vacuum packages;
      wherein the bottom film is formed by or comprises a multilayer film according to any one of the preceding aspects from 1 to 30, with said first external surface of the multilayer film forming part or the entirety of a top surface of the bottom film; or
      wherein the top film is formed by or comprises a multilayer film according to any one of the preceding aspects from 1 to 30, with said first external surface of the multilayer film forming part or the entirety of a bottom surface of the top film; or
      wherein both the top and the bottom film are formed by or comprise a respective multilayer film according to any one of the preceding aspects from 1 to 30, with the multilayer film forming or comprised in the bottom film having the respective first external surface forming part or the entirety of a top surface of the bottom film, and with the multilayer film forming or comprised in the top film having the respective first external surface forming part or the entirety of a bottom surface of the same top film.

In a 65bis aspect according to the preceding aspect, the packaging process is according to any one of the preceding aspects from 48 to 53.

A 66^{th} concerns a packaging process comprising the following steps:
advancing one or more preformed trays along a predetermined path towards a packaging station,
positioning at least one respective product on each one of the one or more trays,
advancing a top film towards the packaging station,
at the packaging station:
   aligning a portion of the top film above said one or more trays,
   evacuating gas present in a volume between said portion of the top film and the one or more trays,
   sealing, optionally heat sealing, said portion of the top film to said one or more trays to form one or more vacuum skin packages;
      wherein the one or more trays are formed by or comprise a multilayer film according to any one of the preceding aspects from 1 to 30, with said first external surface of the multilayer film forming part or the entirety of a top surface of the one or more trays; or
      wherein the top film is formed or comprises by a multilayer film according to any one of the preceding aspects from 1 to 30, with said first external surface of the multilayer film forming part or the entirety of a bottom surface of the top film; or
      wherein both one or more trays and the bottom film are formed by or comprise a respective multilayer film according to any one of the preceding aspects from 1 to 30, with the multilayer film forming or comprised in the one or more trays having the respective first external surface forming part or the entirety of a top surface of the one or more trays, and with the multilayer film forming or comprised in the top film having the respective first external surface forming part or the entirety of a bottom surface of the same top film.

In a 67^{th} aspect according to the preceding aspect, the packaging process is according to any one of the preceding aspects from 48 to 53.

A 68^{th} aspect concerns a package comprising:
the article for packaging according to aspect 38bis, and
a product, optionally a food product,
   wherein the package is hermetically sealed, optionally heat sealed, around the spout or the accommodation for inserting a straw, and optionally a cap is applied to the spout to seal it; and wherein the product is a fluid, optionally having a viscosity below 1000 mPa*s.

A 69^{th} aspect concerns a packaging process comprising:
providing an article for packaging according to aspect 38bis, having an inner volume where one or more fluid products can be hosted;
providing one or more fluid products to be packaged, optionally fluid food products, optionally having a viscosity below 1000 mPa*s;
filling the inner volume of said article for packaging with said one or more fluid products,
hermetically sealing said bag or pouch by sealing, optionally heat sealing, said multilayer film to the accommodation for inserting a straw and/or by applying a cap to the spout.

### Conventions

In the detailed description, in the figures and in the claims, corresponding parts are indicated by same reference numerals even if associated to different embodiments.

The figures may illustrate parts or components or assemblies, including aspects of the invention, by representations that are not in scale; furthermore, the figures may provide schematic representations of aspects of the invention.

Unless otherwise stated, all the percentages are percentages by weight.

### BRIEF DESCRIPTION OF THE DRAWINGS

Some embodiments and some aspects of the invention are described hereinafter with reference to the accompanying drawings, provided only for illustrative and, therefore, non-limiting purposes, in which:

FIG. 1 is a schematic and enlarged cross sectional view of a portion of a first multilayer film of the invention;

FIG. 2 is a schematic and enlarged cross sectional view of a portion of a second multilayer film of the invention;

FIG. 3 is a schematic and enlarged cross sectional view of a portion of a third multilayer film of the invention;

FIG. 4 is a schematic and enlarged cross sectional view of a portion of a fourth multilayer film of the invention;

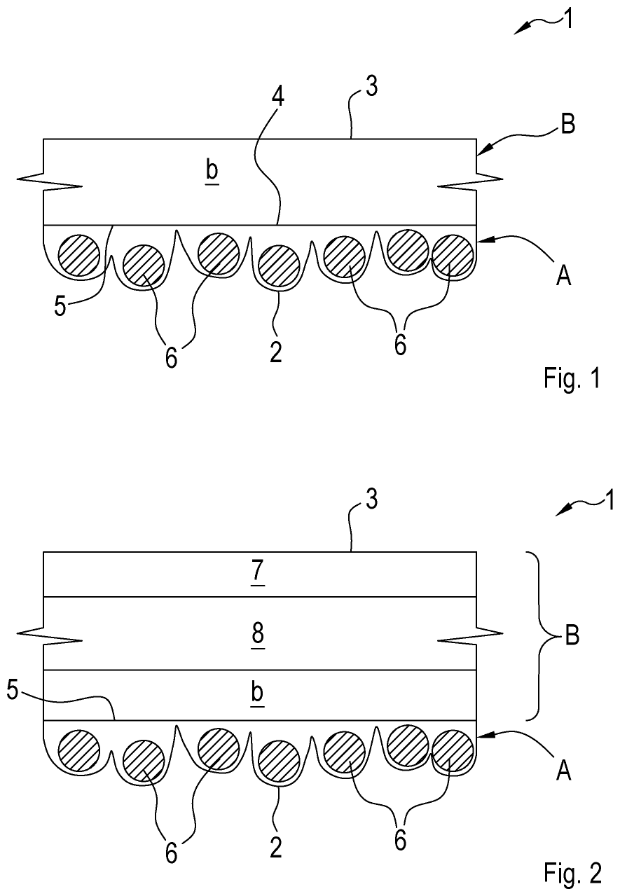

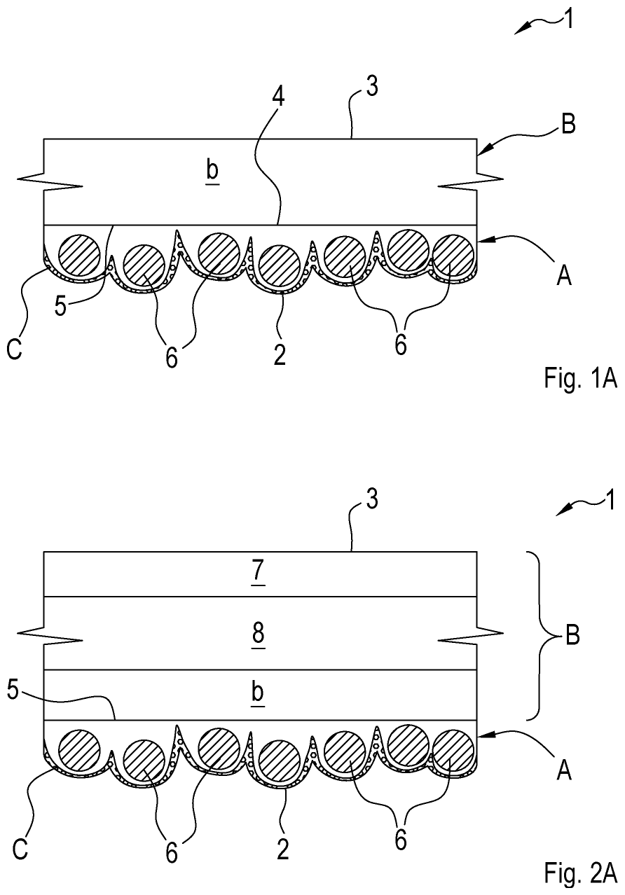

FIG. 1A is a schematic and enlarged cross sectional view of a portion of a variant of the first multilayer film of FIG. 1;

FIG. 2A is a schematic and enlarged cross sectional view of a portion of a variant of the multilayer film of FIG. 2;

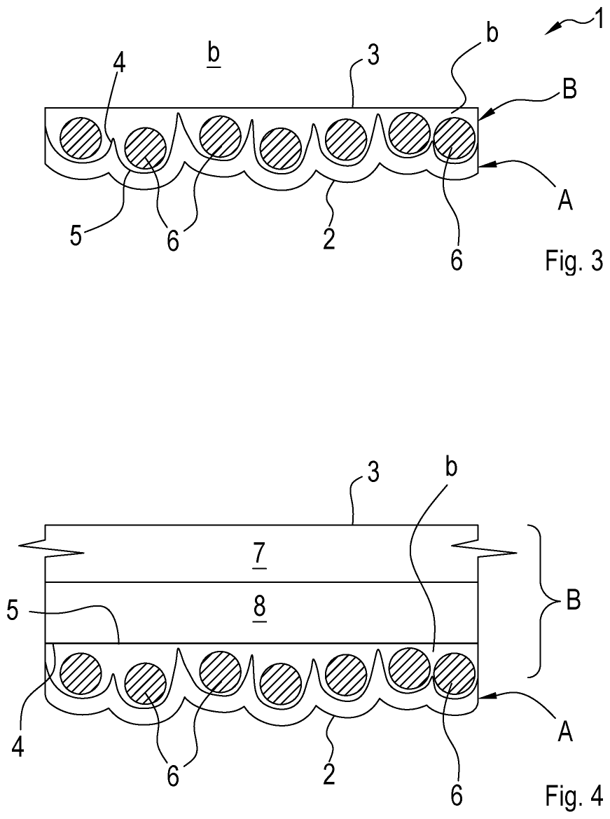

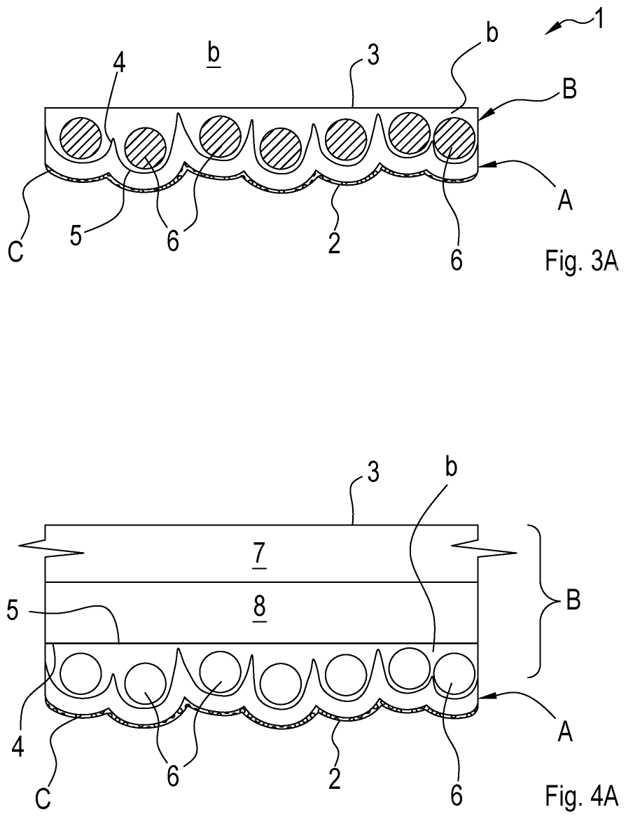

FIG. 3A is a schematic and enlarged cross sectional view of a portion of a variant of the multilayer film of FIG. 3;

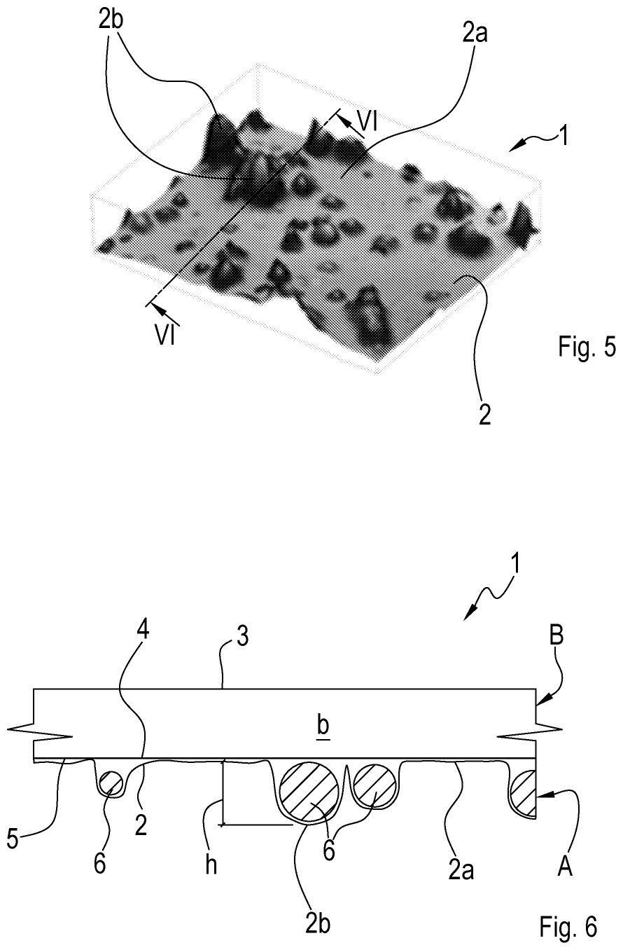

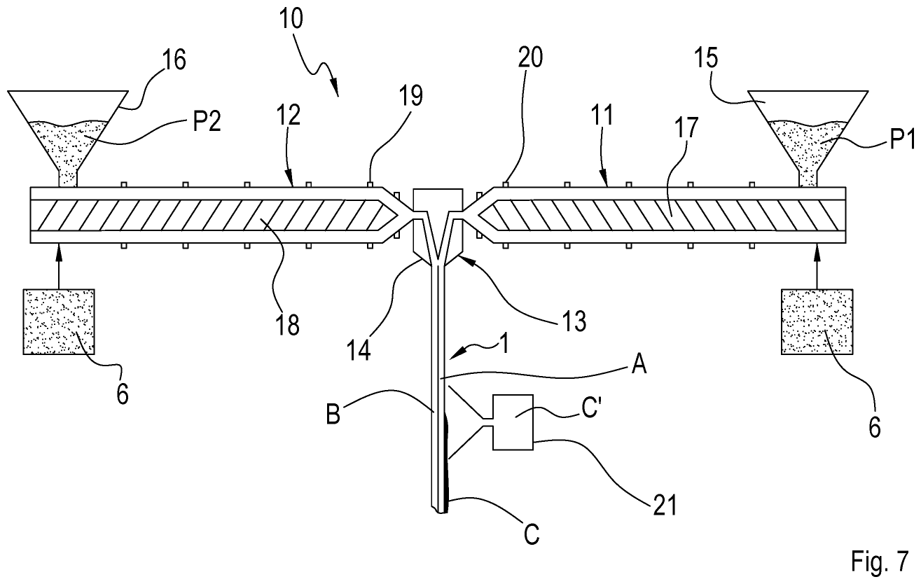

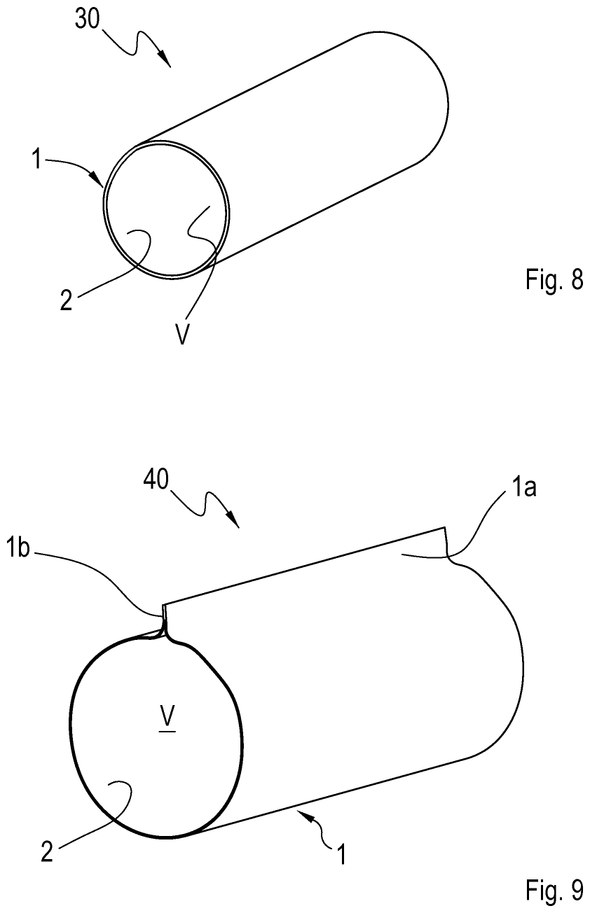

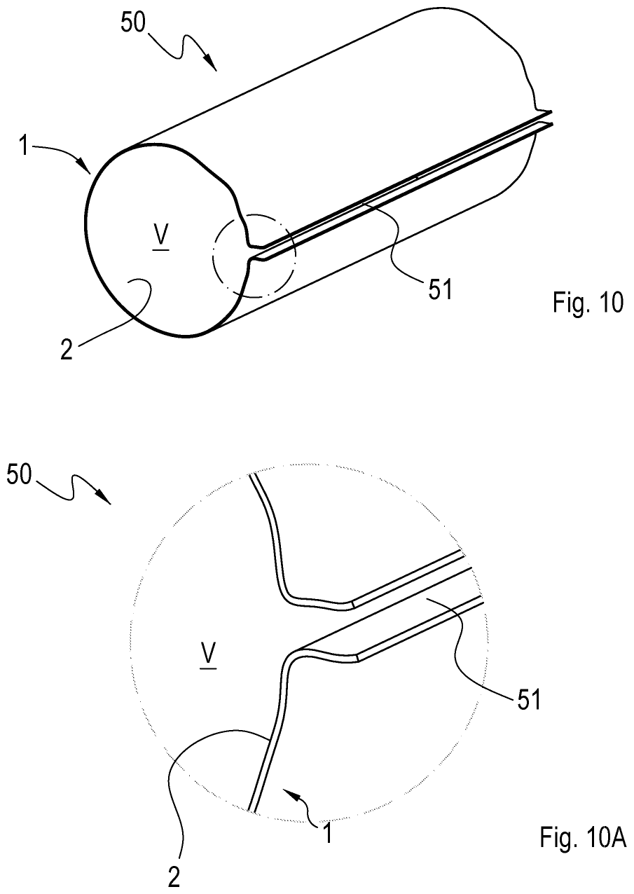

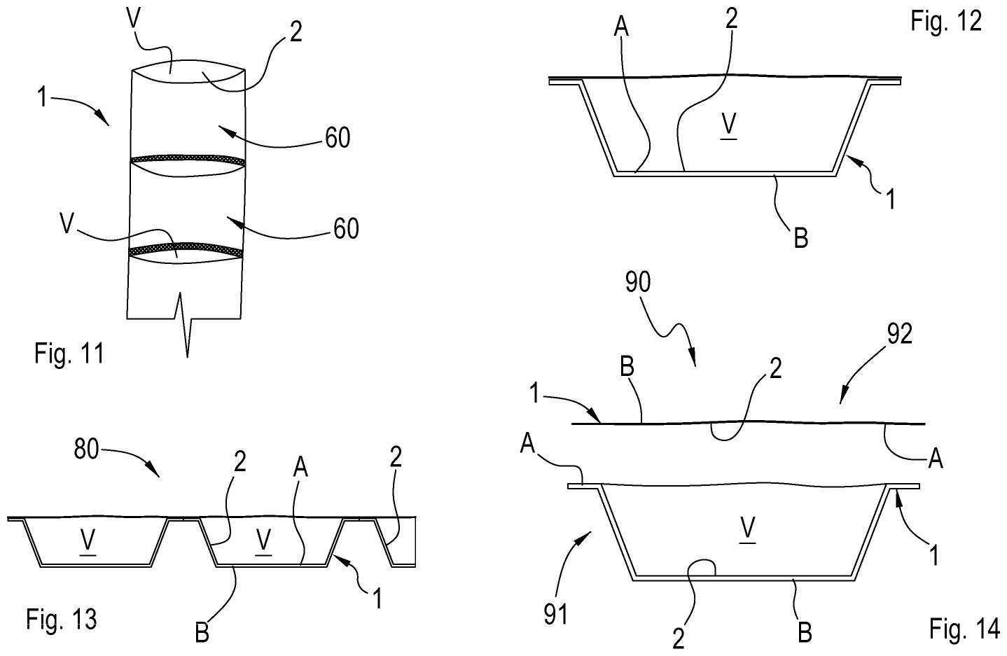

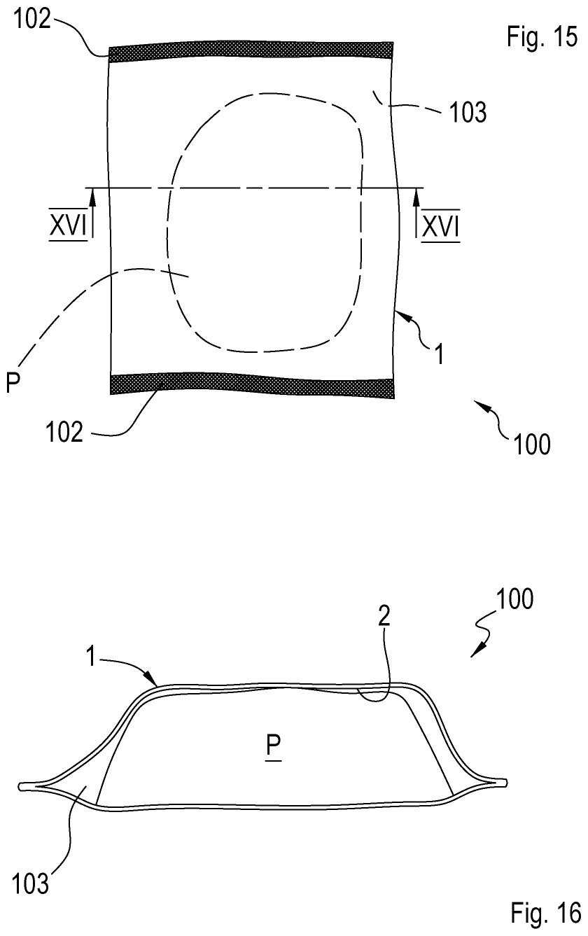

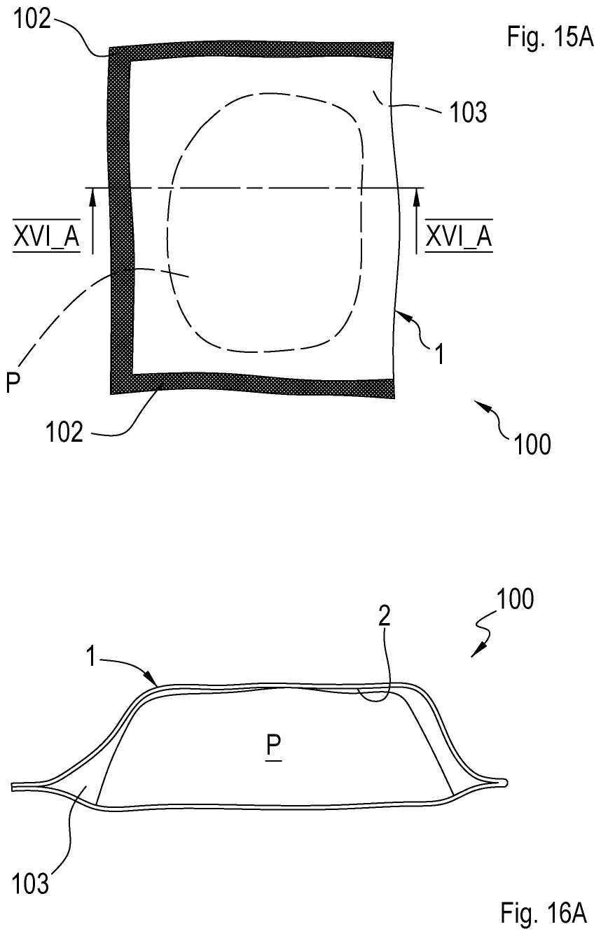

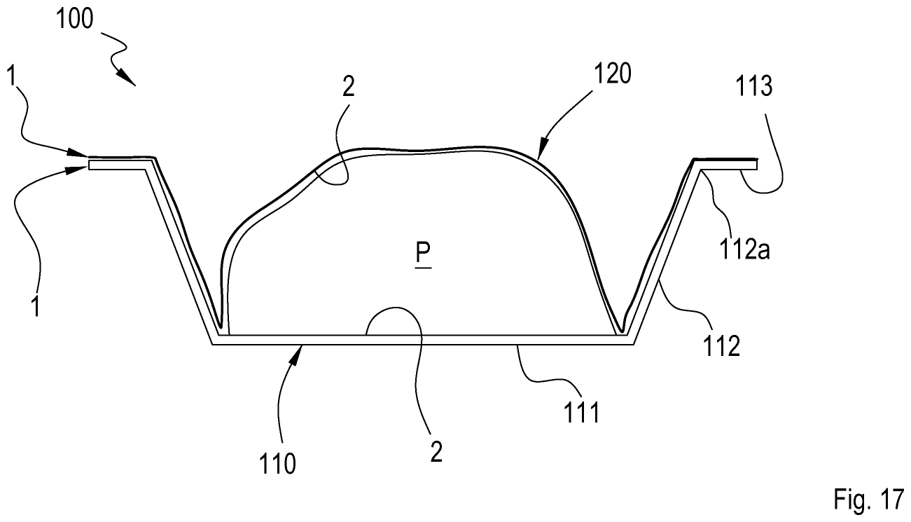

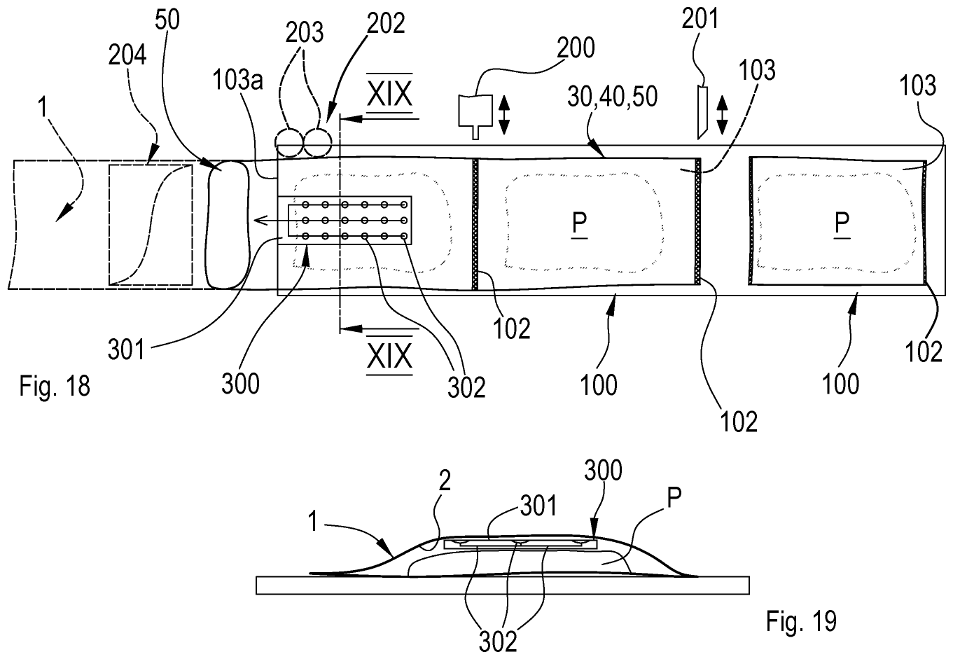

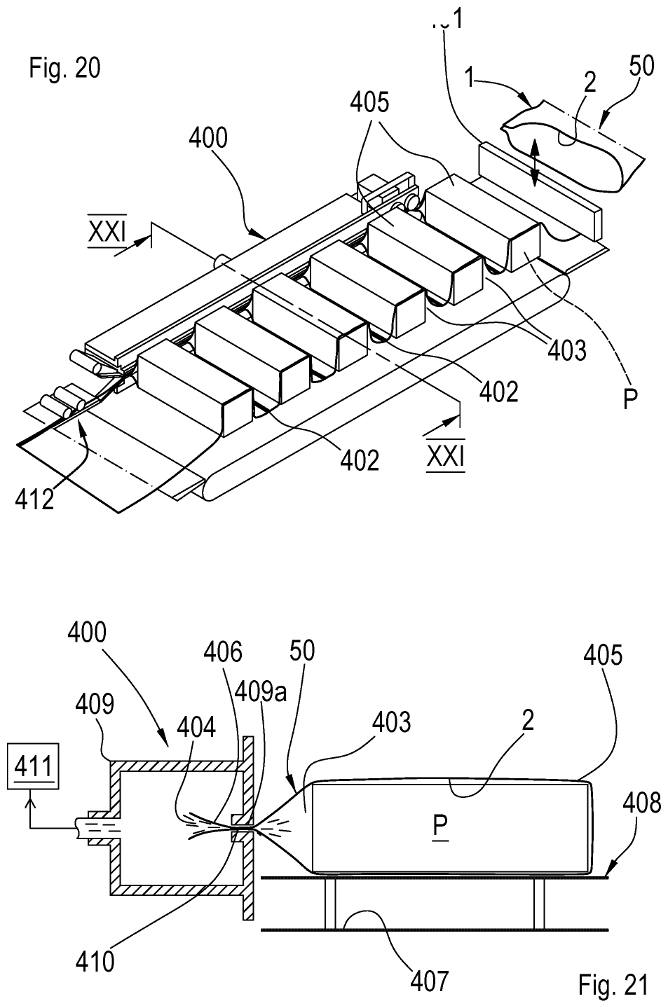

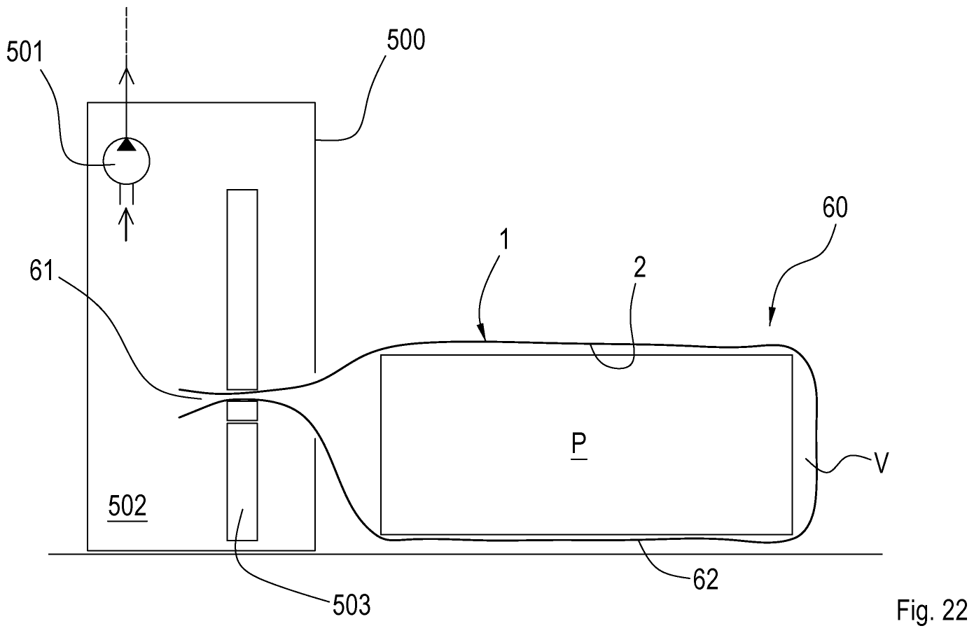

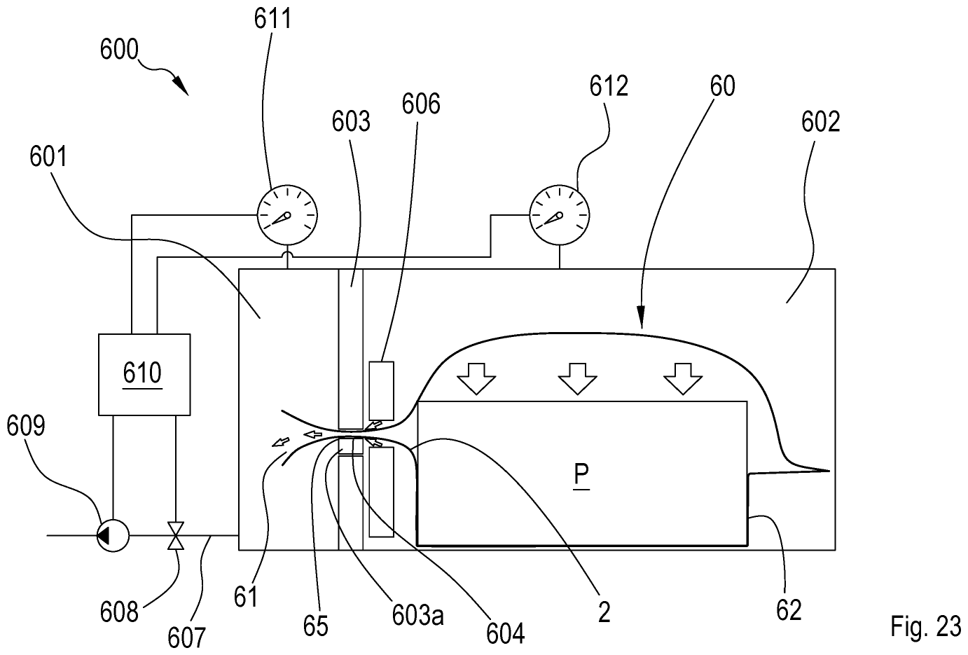

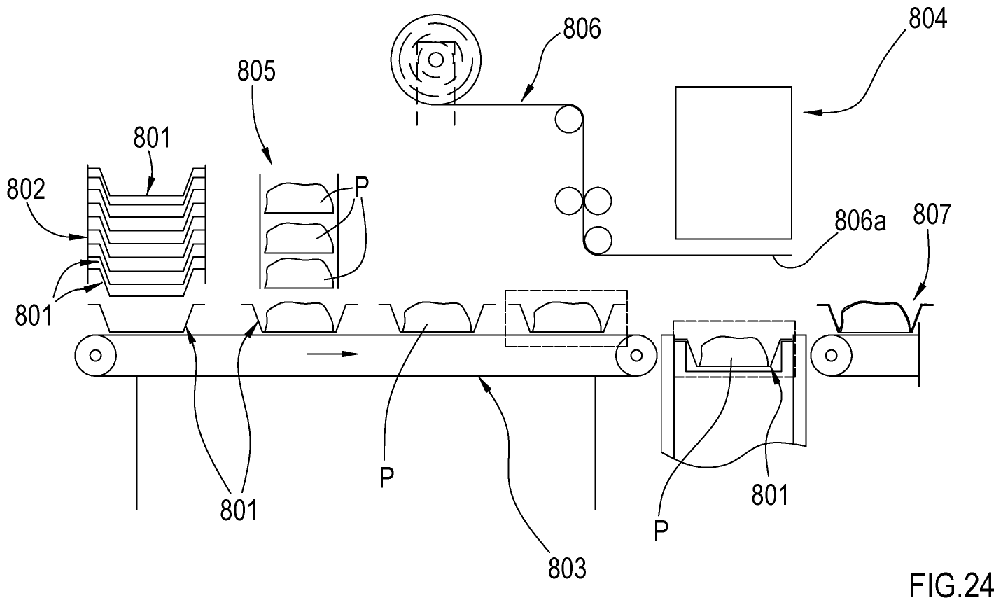

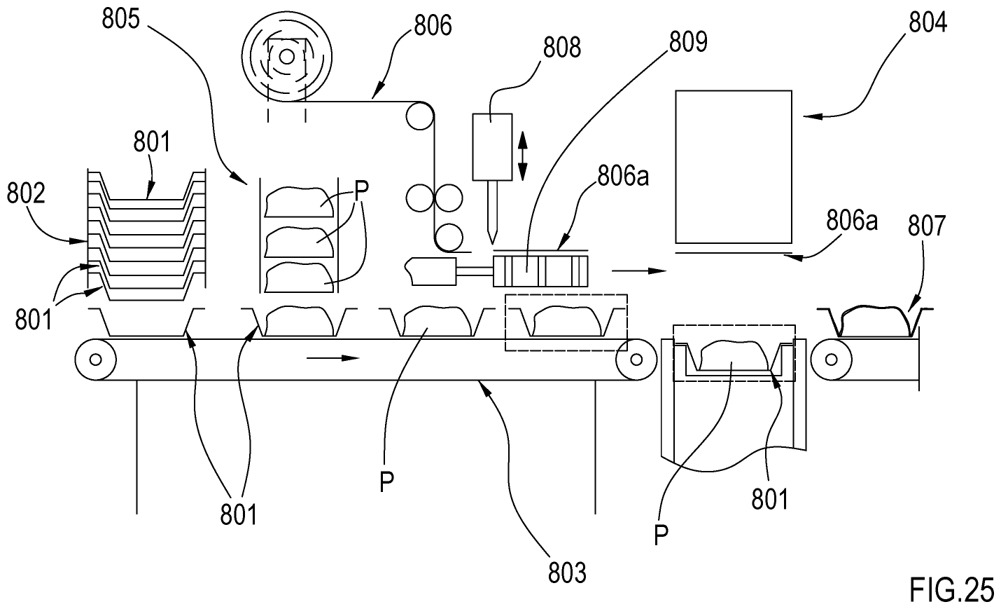

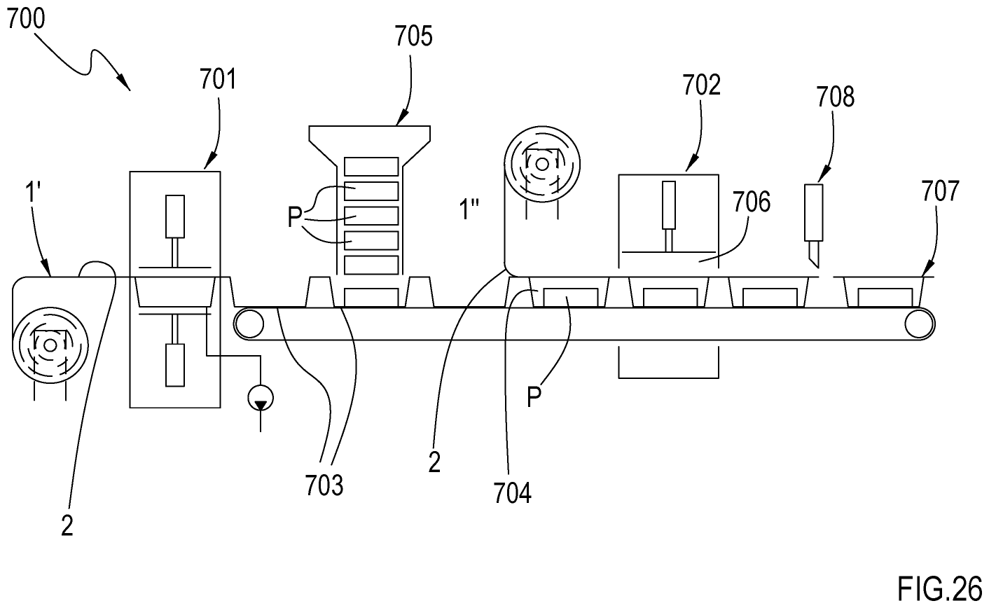

FIG. 4A is a schematic and enlarged cross sectional view of a portion of a variant of the multilayer film of FIG. 4;

FIG. 5 shows a portion of the external surface obtainable using the multilayer film of the invention, for example one of the films of the preceding figures;

FIG. 6 is further schematic cross sectional view of a portion of multilayer film similar to that of FIG. 1;

FIG. 7 is a schematic view of an extrusion line configured for manufacturing the films of any one of the above figures or other films according to the invention;

FIG. 8 shows in perspective view a segment of a first article for packaging obtainable using the multilayered film of the invention;

FIG. 9 shows in perspective view a segment of a second article for packaging obtainable using the multilayered film of the invention;

FIG. 10 shows in perspective view a segment of a third article for packaging obtainable using the multilayered film of the invention;

FIG. 10A shows in perspective view a detail of the third article for packaging of FIG. 10;

FIG. 11 shows a segment of a fourth article for packaging obtainable using the multilayered film of the invention;

FIG. 12 shows a fifth article for packaging obtainable using the multilayered film of the invention;

FIG. 13 shows a segment of a sixth article for packaging obtainable using the multilayered film of the invention;

FIG. 14 shows a segment of a seventh article for packaging obtainable using the multilayered film of the invention;

FIG. 15 shows an eight article for packaging obtainable using the multilayered film of the invention;

FIG. 16 is a cross section along plane XVI-XVI of FIG. 15;

FIG. 15A shows an ninth article for packaging obtainable using the multilayered film of the invention;

FIG. 16A is a cross section along plane XVI_A-XVI_A of FIG. 15A;

FIG. 17 shows a tenth article for packaging obtainable using the multilayered film of the invention;

FIG. 18 shows a top schematic view of a line for making the package of FIG. 15;

FIG. 19 is a schematic sectional view along plane XIX-XIX of FIG. 18;

FIG. 20 shows a schematic perspective view of a line for making a package in the form of a bag or pouch for example using the article of FIG. 10;

FIG. 21 is a schematic sectional view along plane XXI-XXI of FIG. 20;

FIG. 22 shows a schematic sectional view of an apparatus for making a package in the form of a bag or pouch using the multilayer film of the invention, for example the film of the above FIGS. 1 to 4A;

FIG. 23 shows a schematic sectional view of another apparatus for making a package in the form of a bag or pouch using the multilayer film of the invention, for example the film of the above FIGS. 1 to 4A;

FIG. 24 is a schematic view of a packaging line for making a package in the form of a tray, which may be formed using a multilayer film according to the invention, closed by a top film, which may be a multilayer film of the invention;

FIG. 25 is a schematic view of another packaging line for making a package in the form of a tray, which may be formed using a multilayer film according to the invention, closed by a top film, which may be a multilayer film of the invention; and

FIG. 26 is a schematic view of a further packaging line for making a package in the form of a tray, which may be formed using a multilayer film according to the invention, closed by a top film, which may be a multilayer film of the invention.

### DEFINITIONS

### Product

The term product P means an article or a composite of articles of any kind. For example, the product may be of a foodstuff type and be in solid, liquid or gel form, i.e. in the form of two or more of the aforementioned aggregation states. In the food sector, the product may comprise: meat, fish, cheese, processed meat, fresh or frozen ready meals of various kinds.

### Control Unit

The packaging apparatus/process and the apparatus process for making the multilayer film described herein may include at least one control unit designed to perform the steps of the process for making the package. The control unit may be only one or be formed by a plurality of different control units according to the design choices and the operational needs. The term control unit means an electronic component which can comprise at least one of: a digital processor (for example comprising at least one selected from the group of: CPU, GPU, GPGPU), a memory (or memories), an analog circuit, or a combination of one or more digital processing units with one or more analog circuits. The control unit may be “configured” or “programmed” to perform some steps: this can be done in practice by any means that allows configuring or programming the control unit. For example, in the case of a control unit comprising one or more CPUs and one or more memories, one or more programs can be stored in appropriate memory banks connected to the CPU or to the CPUs; the program or programs contain instructions which, when executed by the CPU or the CPUs, program or configure the control unit to perform the operations described in relation to the control unit. Alternatively, if the control unit is or includes analog circuitry, then the control unit circuit may be designed to include circuitry configured, in use, for processing electrical signals so as to perform the steps related to control unit. The control unit may comprise one or more digital units, for example of the microprocessor type, or one or more analog units, or a suitable combination of digital and analog units; the control unit can be configured for coordinating all the actions necessary for executing an instruction and instruction sets.

### Film, Film Layers

As used herein, the term “film” is inclusive of plastic web, regardless of whether it is film or sheet or tubing. The film of the invention is a multilayer film including two or more layers. Each film layer is made of one or more polymeric materials or one or more polymeric materials with the addition of microparticles which may be of a non-polymer material.

As used herein, the terms “inner layer” and “internal layer” refer to any film layer having both of its principal surfaces directly adhered to another layer of the film.

As used herein, the phrase “outer layer” or “external layer” refers to any film layer having only one of its principal surfaces directly adhered to another layer of the film.

As used herein, the phrases “seal layer”, “sealing layer”, “heat seal layer”, and “sealant layer”, refer to an outer layer involved in the sealing of the film to itself, in particular to the same outer seal layer or to the other outer layer of the same film, to another film, and/or to another article which is not a film.

As used herein, the phrases “outer anti-abuse layer”, “outer abuse-resistant layer” and “outer skin layer” refer to an outer layer of the film which, in the final package, is directed towards the environment and not towards the packaged product.

As used herein, the words “tie layer” or “adhesive layer” refer to any inner film layer having the primary purpose of adhering two layers to each other.

As used herein, the phrases “longitudinal direction” and “machine direction”, herein abbreviated “LD” and “MD”, refer to a direction “along the length” of the film, i.e., the direction of the film as the film is formed during coextrusion.

As used herein, the phrase “transverse direction” or “crosswise direction”, herein abbreviated “TD”, refers to a direction across the film, perpendicular to the machine or longitudinal direction.

### Extrusion, Co-Extrusion, Extrusion Coating

As used herein, the term “extrusion” is used with reference to the process of forming continuous shapes by forcing a molten plastic material through a die, followed by cooling (quenching) or chemical hardening. Immediately prior to extrusion through the die, the relatively high-viscosity polymeric material may be fed into a rotating screw of variable pitch, i.e., an extruder, which forces the polymeric material through the die.

As used herein, the term “coextrusion” refers to the process of extruding two or more materials through a single die with two or more orifices arranged so that the extrudates merge and weld together into a laminar structure before chilling, i.e., quenching. The term “coextrusion” as used herein also includes “extrusion coating”.

As used herein, the term “extrusion coating” refers to processes by which a “coating” of molten polymer(s), comprising one or more layers, is extruded onto a solid “substrate” in order to coat the substrate with the molten polymer coating to bond the substrate and the coating together, thus obtaining a complete film.

As used herein the terms “coextrusion”, “coextruded”, “extrusion coating”, “extrusion coated” and the like are referred to processes and multilayer films which are not obtained by sole lamination, namely by gluing or welding together pre-formed webs.

### Vacuum Deposition

As used herein, “vacuum deposition” refers to a process that allows depositing a material molecule-by-molecule or by groups of molecules forming a molecular chain on a solid surface, e.g. a film, to form a layer of this material. The material to be deposited may be a formulated monomer or oligomer in the form of a liquid or a solid. Upon application of vacuum and heat, the material evaporates and then deposits on the film surface. Upon deposition, the material returns to its original state which may be liquid, solid or even gel, if the material is formulated using both a liquid and a solid. As upon heating under vacuum the liquid or solid materials are converted into a vapor, this “vacuum deposition” process is also referred to as vacuum “vapor deposition” process.

### Outer Anti-Abuse Surface

As used herein, the terms “outer anti-abuse surface” or “outer abuse-resistant surface” of a part of a film, of a film or of a package made therefrom mean the outermost surface that, in the final package, is directed towards the environment and not towards the product.

### Roughness

As used herein, the terms “rough surface” or “roughened surface” refer to a surface of a film having a non-smooth pattern, i.e. a surface presenting irregular structures such as, e.g., holes, pillars, spikes, wrinkles, scratches, bumps, indentations etc., wherein such structures are engraved in, or protrude from, the surface.

### Contact Angle θ

The term “contact angle θ” relates to the angle made by a droplet of liquid on a surface of a solid substrate and it is used as a quantitative measure of the wettability of the surface. If the liquid spreads completely across the surface and forms a film, the contact angle θ is 0°. For water, a surface or a coating is usually considered hydrophobic if the contact angle θ is greater than 90°. Surfaces or coatings with water contact angles greater than 130° are also referred to as “super-hydrophobic”.

### Hydrophobic, Super-Hydrophobic

As used herein, the term “super-hydrophobic” refers to the property of a surface to repel water very effectively. This property is expressed by a water contact angle θ exceeding 130°.

As used herein, the term “super-hydrophobic coating composition” refers to a composition that, when applied onto a surface of a thermoplastic film, may form a super-hydrophobic coating.

As used herein, the term “super-hydrophobic coating” relates to a coating characterized by a water contact angle θ higher than 130°, said contact angle θ being measured according to ASTM D7490-13.

As used herein, the term “hydrophobic” refers to the property of a surface to repel water with a water contact angle θ from about 90° to about 130.

As used herein, the term “hydrophobic coating composition” refers to a hydrophobic coating composition comprising components that have the ability to form a hydrophobic coating, upon curing and/or drying.

### Major Amount, Major Proportion, Minor Amount, Minor Proportion

As used herein, the term “major amount” or “major proportion” refer to an amount of a component higher than 50% by weight in respect of the total amount by weight of the components of a referred element (e.g. a film, a layer etc.).

As used herein, the term “minor amount” or “minor proportion” refer to an amount of a component lower than 50% by weight in respect of the total amount by weight of the components of a referred element (e.g. a film, a layer etc.).

### Polymer

As used herein, the term “polymer” refers to the product of a polymerization reaction, and is inclusive of homo-polymers, and co-polymers.

As used herein, the term “homo-polymer” is used with reference to a polymer resulting from the polymerization of a single type of monomer, i.e., a polymer consisting essentially of a single type of mer, i.e., repeating unit.

As used herein, the term “co-polymer” refers to polymers formed by the polymerization reaction of at least two different types of monomers. For example, the term “co-polymer” includes the co-polymerization reaction product of ethylene and an alpha-olefin, such as 1-hexene. When used in generic terms the term “co-polymer” is also inclusive of, for example, ter-polymers. The term “co-polymer” is also inclusive of random co-polymers, block co-polymers, and graft co-polymers.

As used herein, the term “polymer” is inclusive of heterogeneous polymers and homogeneous polymers.

As used herein, the phrase “heterogeneous polymer” or “polymer obtained by heterogeneous catalysis” refers to polymerization reaction products of relatively wide variation in molecular weight and relatively wide variation in composition distribution, i.e., typical polymers prepared, for example, using conventional Ziegler-Natta catalysts, for example, metal halides activated by an organometallic catalyst, i.e., titanium chloride, optionally containing magnesium chloride, complexed to trialkyl aluminum and may be found in patents such as U.S. Pat. No. 4,302,565 to Goeke et al. and U.S. Pat. No. 4,302,566 to Karol, et al. Heterogeneous catalyzed copolymers of ethylene and an alpha-olefin may include linear low-density polyethylene (LLDPE), very low-density polyethylene (VLDPE) and ultra-low-density polyethylene (ULDPE). Some copolymers of this type are available from, for example, The Dow Chemical Company, of Midland, Michigan., U.S.A. and sold under the trademark DOWLEX resins.

As used herein, the phrase “homogeneous polymer” or “polymer obtained by homogeneous catalysis” refers to polymerization reaction products of relatively narrow molecular weight distribution and relatively narrow composition distribution. Homogeneous polymers are structurally different from heterogeneous polymers, in that homogeneous polymers exhibit a relatively even sequencing of co-monomers within a chain, a mirroring of sequence distribution in all chains, and a similarity of length of all chains, i.e., a narrower molecular weight distribution. This term includes those homogeneous polymers prepared using metallocenes, or other single-site type catalysts, as well as those homogenous polymers that are obtained using Ziegler Natta catalysts in homogenous catalysis conditions.

The co-polymerization of ethylene and alpha-olefins under homogeneous catalysis, for example, co-polymerization with metallocene catalysis systems which include constrained geometry catalysts, i.e., monocyclopentadienyl transition-metal complexes is described in U.S. Pat. No. 5,026,798 to Canich. Homogeneous ethylene/alpha-olefin copolymers (E/AO) may include modified or unmodified ethylene/alpha-olefin copolymers having a long-chain branched (8-20 pendant carbons atoms) alpha-olefin comonomer available from The Dow Chemical Company, known as AFFINITY and ATTANE resins, TAFMER linear copolymers obtainable from the Mitsui Petrochemical Corporation of Tokyo, Japan, and modified or unmodified ethylene/alpha-olefin copolymers having a short-chain branched (3-6 pendant carbons atoms) alpha-olefin comonomer known as EXACT resins obtainable from ExxonMobil Chemical Company of Houston, Texas, U.S.A.

As used herein, the term “polyolefin” refers to any polymerized olefin, which can be linear, branched, cyclic, aliphatic, aromatic, substituted, or unsubstituted. More specifically, included in the term polyolefin are homo-polymers of olefin, co-polymers of olefin, co-polymers of an olefin and a non-olefinic co-monomer co-polymerizable with the olefin, such as vinyl monomers, modified polymers thereof, and the like. Specific examples include polyethylene homo-polymer, polypropylene homo-polymer, polybutene homo-polymer, ethylene-alpha-olefin which are copolymers of ethylene with one or more-alpha-olefins such as butene-1, hexene-1, octene-1, or the like as a comonomer, and the like, propylene-alpha-olefin co-polymer, butene-alpha-olefin co-polymer, ethylene-unsaturated ester co-polymer, ethylene-unsaturated acid co-polymer, (e.g. ethylene-ethyl acrylate co-polymer, ethylene-butyl acrylate co-polymer, ethylene-methyl acrylate co-polymer, ethylene-acrylic acid co-polymer, and ethylene-methacrylic acid co-polymer), ethylene-vinyl acetate copolymer, ionomer resin, polymethylpentene, etc.

As used herein, the term “Cyclo olefin copolymers (COC)” refers to amorphous, transparent thermoplastics produced by copolymerization of cycloolefins such as norbornene or cyclopentadiene with ethylene using a metallocene catalyst.

As used herein the term “ionomer” refers to the products of polymerization of ethylene with an unsaturated organic acid, and optionally also with an unsaturated organic acid (C1-C4)-alkyl ester, partially neutralized with a mono- or divalent metal ion, such as lithium, sodium, potassium, calcium, magnesium and zinc. Typical unsaturated organic acids are acrylic acid and methacrylic acid, which are thermally stable and commercially available. Unsaturated organic acid (C1-C4)-alkyl esters are typically (meth)acrylate esters, e.g. methyl acrylate and isobutyl acrylate. Mixtures of more than one unsaturated organic acid comonomer and/or more than one unsaturated organic acid (C1-C4)-alkyl ester monomer can also be used in the preparation of the ionomer.

As used herein, the phrase “modified polymer”, as well as more specific phrases such as “modified ethylene/vinyl acetate copolymer”, and “modified polyolefin” refer to such polymers having an anhydride functionality, grafted thereon and/or copolymerized therewith and/or blended therewith. Preferably, such modified polymers have the anhydride functionality grafted on or polymerized therewith, as opposed to merely blended therewith. As used herein, the term “modified” refers to a chemical derivative, e.g. one having any form of anhydride functionality, such as anhydride of maleic acid, crotonic acid, citraconic acid, itaconic acid, fumaric acid, etc., whether grafted onto a polymer, copolymerized with a polymer, or blended with one or more polymers, and is also inclusive of derivatives of such functionalities, such as acids, esters, and metal salts derived therefrom.

As used herein, the phrase “anhydride-containing polymer” and “anhydride-modified polymer” refer to one or more of the following: (1) polymers obtained by copolymerizing an anhydride-containing monomer with a second, different monomer, and (2) anhydride grafted copolymers, and (3) a mixture of a polymer and an anhydride-containing compound.

As used herein, the phrase “ethylene-alpha-olefin copolymer” refers to heterogeneous and to homogeneous polymers such as linear low density polyethylene (LLDPE) with a density usually in the range of from about 0.900 g/cc to about 0.930 g/cc, linear medium density polyethylene (LMDPE) with a density usually in the range of from about 0.930 g/cc to about 0.945 g/cc, and very low and ultra-low density polyethylene (VLDPE and ULDPE) with a density lower than about 0.915 g/cc, typically in the range 0.868 to 0.915 g/cc, and such as metallocene-catalyzed EXACT™ and EXCEED™ homogeneous resins obtainable from Exxon, single-site AFFINITY™ resins obtainable from Dow, and TAFMER™ homogeneous ethylene-alpha-olefin copolymer resins obtainable from Mitsui. All these materials generally include co-polymers of ethylene with one or more co-monomers selected from (C4-C10)-alpha-olefin such as butene-1, hexene-1, octene-1, etc., in which the molecules of the copolymers comprise long chains with relatively few side chain branches or cross-linked structures.

As used herein, the term “EVA” refers to ethylene and vinyl acetate copolymers. The vinylacetate monomer unit can be represented by the general formula: [CH3COOCH═CH2].

As used herein, the phrase “acrylates or acrylate-based resin” refers to homopolymers, copolymers, including e.g. bipolymers, terpolymers, etc., having an acrylate moiety in at least one of the repeating units forming the backbone of the polymer. In general, acrylate-based resins are also known as polyalkyl acrylates. Acrylate resins or polyalkyl acrylates may be prepared by any method known to those persons skill in the art. Suitable examples of these resins for use in the present invention include ethylene/methacrylate copolymers (EMA), ethylene/butyl acrylate copolymers (EBA), ethylene/methacrylic acid (EMAA), ethylene/methyl methacrylate (EMMA), optionally modified with carboxylic or preferably anhydride functionalities, ionomers and the like. Such as LOTRYL 18 MA 002 by Arkema (EMA), Elvaloy AC 3117 by Du Pont (EBA), Nucrel 1202HC by Du Pont (EMAA), Surlyn 1061 by Du Pont (Ionomer).

As used herein the term “polyamide” refers to high molecular weight polymers having amide linkages along the molecular chain, and refers more specifically to synthetic polyamides such as nylons. Such term encompasses both homo-polyamides and co-(or ter-) polyamides. It also specifically includes aliphatic homo-polyamides or co-polyamides, aromatic homo-polyamides or co-polyamides, and partially aromatic homo-polyamides or co-polyamides, modifications thereof and blends thereof. The homo-polyamides are derived from the polymerization of a single type of monomer comprising both the chemical functions, which are typical of polyamides, i.e. amino and acid groups, such monomers being typically lactams or aminoacids, or from the polycondensation of two types of polyfunctional monomers, i.e. polyamines with polybasic acids. The co-, ter-, and multi-polyamides are derived from the copolymerization of precursor monomers of at least two (three or more) different polyamides. As an example in the preparation of the co-polyamides, two different lactams may be employed, or two types of polyamines and polyacids, or a lactam on one side and a polyamine and a polyacid on the other side. Exemplary polymers are polyamide 6, polyamide 6/9, polyamide 6/10, polyamide 6/12, polyamide 11, polyamide 12, polyamide 6/12, polyamide 6/66, polyamide 66/6/10, modifications thereof and blends thereof. Said term also includes crystalline or partially crystalline, aromatic or partially aromatic polyamides.

As used herein, the phrase “amorphous polyamide” refers to polyamides or nylons with an absence of a regular three-dimensional arrangement of molecules or subunits of molecules extending over distances, which are large relative to atomic dimensions. However, regularity of structure exists on a local scale. See, “Amorphous Polymers,” in Encyclopedia of Polymer Science and Engineering, 2^{nd} Ed., pp. 789-842 (J. Wiley & Sons, Inc. 1985). This document has a Library of Congress Catalogue Card Number of 84-19713. In particular, the term “amorphous polyamide” refers to a material recognized by one skilled in the art of differential scanning calorimetry (DSC) as having no measurable melting point (less than 0.5 cal/g) or no heat of fusion as measured by DSC using ASTM 3417-83. Such nylons include those amorphous nylons prepared from condensation polymerization reactions of diamines with dicarboxylic acids. For example, an aliphatic diamine is combined with an aromatic dicarboxylic acid, or an aromatic diamine is combined with an aliphatic dicarboxylic acid to give suitable amorphous nylons.

As used herein, the term “polyester” refers to homopolymers or copolymers (also known as “copolyesters”) having an ester linkage between monomer units which may be formed, for example, by condensation polymerization reactions of lactones or by polymerization of dicarboxylic acid(s) and glycol(s). With the term “(co) polyesters” both homo and copolymers are intended.

As used herein, the term “aromatic polyester” refers to homopolymers or copolymers (also known as “copolyesters”) having an ester linkage between one or more aromatic or alkylsubstituted aromatic dicarboxylc acids and one or more glycols.

### Adhered, Directly Adhered

As used herein, the term “adhered” is inclusive of films which are directly adhered to one another using a heat-seal or other means, as well as films which are adhered to one another using an adhesive which is between the two films.

As used herein, the phrase “directly adhered”, as applied to layers, is defined as adhesion of the subject layer to the object layer, without a tie layer, adhesive, or other layer therebetween.

### Between

In contrast, as used herein, the word “between”, as applied to a layer expressed as being between two other specified layers, includes both direct adherence of the subject layer to the two other layers it is between, as well as a lack of direct adherence to either or both of the two other layers the subject layer is between, i.e., one or more additional layers can be imposed between the subject layer and one or more of the layers the subject layer is between.

### Gas-Barrier

As used herein the term “gas-barrier” when referred to a layer, to a resin contained in said layer, or to an overall structure, refers to the property of the layer, resin or structure, to limit to a certain extent passage through itself of gases.

When referred to a layer or to an overall structure, the term “gas-barrier” is used herein to identify layers or structures characterized by an Oxygen Transmission Rate (evaluated at 23° C. and 0% R.H. according to ASTM D-3985) of less than 500 cc/m²·day·atm, optionally lower than 100 cc/m²·day·atm, even more optionally lower than 50 cc/m²·day·atm.

### Flexible Container

As used herein, the phrase “flexible container” is inclusive of bags and pouches, in particular of end-seal, side-seal, L-seal, U-seal bags and pouches, stand-up pouches, back-seamed tubings and seamless tubings.

### Tray

As used herein, the term “tray” refers to a support which may be flat or may include a base, a side wall emerging from the base wall perimeter, and optionally a top flange radially emerging from the top part of the side wall. The tray may be made in polymer material or it may be formed using the multilayer film of the invention and thus include non-polymer microparticles. The tray may comprise a paper or paperboard layer and/or a layer in non-polymer material.

### Package

As used herein, the term “package” is inclusive of packages made from or comprising the multilayer film of the invention such as flexible containers, or packages using one or more trays coupled with one or more films.

### Average Particle Diameter

As used herein the term “average particle diameter” refers to the average diameter measured with a scanning electron microscope (FE-SEM), which can also be used in combination with another electron microscope such as a transmission electron microscope if the resolution of the scanning electron microscope is too low. Specifically, taking the particle diameter when the particles are spherical and the average of the longest dimension and shortest dimension as the diameter when they are non-spherical, the average particle diameter is the average of the diameters of 20 randomly-selected particles observed by scanning electron microscopy or the like.

### Microparticles

As used herein the term “micro-particles” refers to particles having an average particle diameter from 0.5 to 100 microns.

### DETAILED DESCRIPTION

### The Multilayer Film of the Embodiments Shown in FIGS. 1 and 1A

A first embodiment of a multilayer film 1 according to aspects the invention is shown in FIG. 1. The multilayer film 1 is designed for packaging applications and particularly configured for vacuum packaging. In accordance with an aspect, the multilayer film 1 may be used for vacuum skin packaging. The multilayer film 1 has a first external surface 2 and a second external surface 3 opposite to the first external surface 2. In practice, the first external surface 2 is destined to form an inner surface of a package, for example of a vacuum package, obtainable with the multilayer film 1: in other words, the first external surface 2 of the multilayer film 1 is destined to contact a product hosted in the vacuum package obtainable with film 1, while the second external surface 3 is destined to define part or the entirety of the outer anti-abuse surface of the package.

The multilayer packaging film 1 comprises:
An outer thermoplastic heat-sealable layer A,
a thermoplastic mono or multilayer base layer B directly adhered to layer A.

In the embodiment of FIG. 1 the heat sealable layer A and the base layer B are both a monolayer. Thus, base layer B and heat sealable layer A are both outer layers. On the other hand, as described below in connection with other embodiments of the invention, nothing excludes that base layer B may present a multilayer structure.

In greater detail, the base layer B of film 1 of FIG. 1 has one of its principal surfaces defining the second external surface 3, while the other of the principal surfaces (indicated with reference numeral 4) of the base layer B is directly adhered to one of the principal surfaces (indicated with reference numeral 5) of the heat-sealable layer A. On its turn, heat-sealable layer A has the other principal surface defining the first external surface 2 of the film 1.

As it may be seen from FIG. 1 microparticles 6 are incorporated at least in the heat-sealable layer A. The microparticles 6 are sized and positioned such that one or more regions of the first external surface 2 of the multilayer film present a Mean Roughness Depth (Rz) of at least 4.5 μm, measured according to ISO4287.

In the embodiment of FIG. 1 the entire first external surface 2 of the multilayer film has a Mean Roughness Depth (Rz) of at least 4.5 μm, measured according to ISO4287.

In an aspect, one or more regions of the first external surface 2 of the multilayer film 1 of FIG. 1, for example the entire first external surface 2, may present a Mean Roughness Depth (Rz) of at least 5.0 μm, measured according to ISO4287.

From a structural point of view, the microparticles 6 of the film 1 of FIG. 1 are spherical. On the other hand, the microparticles may alternatively take other shapes such as spheroid or ovoid or teardrop shaped. The microparticles 6 may be hollow or non-hollow, non-hollow microparticles being a currently preferred option. The microparticles 6 may have an average particle diameter comprised between 10 and 110 μm, optionally between 20 and 100 μm, more optionally between 30 and 90 μm.

The microparticles 6 used in the embodiment of FIG. 1 are non-hollow spherical microparticles presenting an average particle diameter from 10 to 110 μm, optionally from 20 to 100 μm, more optionally from 30 to 90 μm. As indicated above also non-spherical particles may be used although shapes close to the spherical shape and deprived of sharpened or pointed shapes are currently considered preferred. In term of volumes, the spherical or non-spherical microparticles present a particle volume from 5.2·10² μm³ to 7.0·10⁵ μm³, optionally from 4.1·10³ μm³ to 5.2·10⁵ μm³, more optionally from 1.4·10⁴ μm³ to 3.8·10⁵ μm³.

In the first embodiment of FIG. 1 the microparticles are fully incorporated in the heat-sealable layer A: in other words, each of said microparticles is entirely embedded in thermoplastic material forming the heat-sealable layer A. In greater detail, the microparticles embedded in the heat-sealable layer A are present in amount of at least 5% by weight calculated in respect of the total weight of the same heat-sealable layer A.

Higher amounts of microparticles may be desirable: for example, the microparticles in the heat-sealable layer A may be present in amount which is:
from 5% to 60% by weight calculated in respect of the total weight of said heat-sealable layer A, or
from 15% to 55% by weight calculated in respect of the total weight of said heat-sealable layer A, or
from 25% to 50% by weight calculated in respect of the total weight of said heat-sealable layer A.

A minor quantity of microparticles in the base layer B is not excluded in principle, such as microparticles in amount lower than 10% by weight, lower than 5% by weight, lower than 1% by weight calculated in respect of the total weight of said mono or multilayer base layer B. As the contribute to the Mean Roughness Depth (Rz) of the first external surface 2 is mostly given by microparticles present in the heat sealable layer A, layer A comprises a major proportion of the total amount of microparticles present in the whole film 1, optionally an amount of more than 60 wt %, more than 70 wt %, more than 80 wt %, more than 90 wt %, more than 95 wt %, more than 99 wt % of the total amount of microparticles present in the whole film 1. Optionally, layer A comprises the totality of the microparticles, i.e. layer B does not comprise microparticles.

Possible materials for the microparticles are indicated in below dedicated section MATERIALS FOR THE MICROPARTICLES.

Moving now to a more detailed description of the thickness of each layer and of the relative size of the microparticles, it is noted that the heat sealable layer A has an average thickness from 1 to 30 μm, optionally from 2 to 20 μm; the monolayer base layer B consists of support layer b directly adhered to the heat sealable layer A and having average thickness from 15 to 80 μm, optionally from 20 to 70 μm.

As to the microparticles 6, they have a particle size or average particle diameter of at least 20%, optionally at least 30%, more optionally at least 50%, greater than the average thickness of the heat-sealable layer A in which the microparticles are incorporated.

In term of materials, it is noted that the heat sealable layer A and the base layer B of the multilayer film 1, with the exception of the microparticles, are formed from one or more thermoplastic materials. Details of the materials for each one of the layers A and B are reported in below dedicated sections (MATERIALS FOR HEAT SEALABLE LAYER A, MATERIALS FOR BASE LAYER B).

In a currently preferred version of the film of FIG. 1, the microparticles are absent from the base layer B, and are present in the heat sealable layer A only. The microparticles are spherical, non-hollow, present a diameter from 30 to 90 μm and are present in the heat-sealable layer A in an amount from 25% to 40% by weight calculated in respect of the total weight of said heat-sealable layer A. Furthermore, the heat sealable layer A has an average thickness from 2 to 20 μm and the monolayer base layer B consists of support layer b directly adhered to the heat sealable layer and having average thickness from 3 to 70 μm. Furthermore, the first external surface 2 of film 1 has Mean Roughness Depth (Rz) greater than 5 μm, while the second external surface 3 of film 1 is smooth or presents a Mean Roughness Depth (Rz) less than 1.5 μm (Rz being measured according to ISO4287).

As it is visible from FIG. 6 (assuming to place film 1 on a flat support) the first external surface 2 of the film 1, by virtue of the presence of the microparticles 6 in the heat-sealable layer A, is a patterned surface(s) comprising a substantially smooth base surface, in those areas 2a where the first external surface 2 has no underlying microparticles, and micro-protrusions emerging relative to the smooth base surface in those areas 2b where the first surface 2 has underlying microparticles: placing the film on a flat surface it is possible to measure the distance (h) between crests of the micro-protrusions and the smooth base surface (again with the film 1 resting on a flat surface for the purpose of the measure), wherein according to aspects of the invention said distance (h) is comprised between 30 and 100 μm, optionally between 40 and 80 μm.

Finally, it is noted that in the multilayer film 1 of FIG. 1 the heat-sealable layer A has a free and not further coated surface defining the first external surface 2 destined to contact the product.

The variant of FIG. 1A is identical to that of FIG. 1, with the exception of the presence of a hydrophobic or super-hydrophobic layer C coated onto the surface of the heat-sealable layer A not directly adhered to the base layer B: thus in the case of FIG. 1A the first external surface 2 is defined (at least in part) by the hydrophobic or super-hydrophobic layer C, which is an outer coating.

In accordance with an aspect, layer C is a super-hydrophobic layer made from an inorganic composition comprising hydrophobic oxide nanoparticles having an average particle diameter from 3 to 100 nm.

The super-hydrophobic layer C has an average thickness from 0.1 to 5.0 microns, optionally from 0.2 to 4 microns, more optionally from 1.0 to 2.5 microns.

The hydrophobic oxide nanoparticles of the super-hydrophobic layer C have an average particle diameter of 3 to 100 nm, preferably 5 to 50 nm, more preferably 5 to 20 nm.

The average particle diameter can be measured with a scanning electron microscope (FE-SEM), possibly in combination with an electron microscope such as a transmission electron microscope. The specific surface area (BET method) of the hydrophobic oxide nanoparticles is not particularly limited, but is normally 50 to 300 m²/g, optionally 100 to 300 m²/g, measured according to ISO 9277. The amount of the hydrophobic oxide nanoparticles deposited onto the outer surface of the heat-sealable layer A (grammage after drying) is from 0.01 to 10 g/m², optionally from 0.1 to 2.0 g/m², more optionally from 0.2 to 1.5 g/m².

The super-hydrophobic layer coating C confers to the first external surface 2 of the film 1 super-hydrophobic properties. For example, the first external surface 2 may be characterized by a water contact angle θ higher than 130°, optionally higher than 140°, more optionally higher than 150°, even more optionally higher than 160° measured according to ASTM D7490-13.

The super-hydrophobic layer coating C is a single layer coating but a multilayer coating is also possible. Possible materials for layers C are reported in below dedicated section (MATERIALS FOR SUPER-HYDROPHOBIC LAYER C).

### The Multilayer Film of the Embodiments Shown in FIGS. 2 and 2A

A second embodiment of a multilayer film 1 according to aspects of the invention is shown in FIG. 2. Also the multilayer film 1 of FIG. 2 is designed for packaging applications and particularly configured for vacuum packaging. In accordance with an aspect, the multilayer film 1 may be used for vacuum packaging. In another aspect, the multilayer film 1 may be used for vacuum skin packaging.

The multilayer film 1 has a first external surface 2 and a second external surface 3 opposite to the first external surface 2. In practice, the first external surface 2 is destined to form an inner surface of a package, for example of a vacuum package, obtainable with the multilayer film 1: in other words, the first external surface 2 of the multilayer film 1 is destined to contact a product hosted in the vacuum package obtainable with film 1, while the second external surface 3 is destined to define part or the entirety of the outer anti-abuse surface of the package.

The multilayer packaging film 1 comprises:
an outer thermoplastic heat-sealable layer A,
a thermoplastic multilayer base layer B directly adhered to layer A.

In the embodiment of FIG. 2 the heat sealable layer A is the layer comprising the microparticles 6 and is identical to that of FIG. 1 (and thus not further described), whilst the base layer B is multilayer. In detail, the base layer B is multilayer having a support layer b directly adhered to the heat-sealable layer A: the support layer b is identical to the support layer b of the monolayer base layer B of the example of FIG. 1 (and thus also not further described to avoid repetitions).

Different from FIG. 1, the multilayer base layer B of the film of FIG. 2 includes the outermost anti-abuse layer 7 and an inner gas barrier layer 8: of course further inner layers may be present depending upon the intended application of film 1.

Optionally, micro-particles may be present in the inner film layer(s) although in a currently preferred solution no microparticles are incorporated into the barrier layer 8 to avoid damages to its gas barrier properties. As described in regard to the film of FIG. 1, layer A comprises a major proportion of the total amount of microparticles present in the whole film 1, optionally an amount of more than 60 wt %, more than 70 wt %, more than 80 wt %, more than 90 wt %, more than 95 wt %, more than 99 wt % of the total amount of microparticles present in the whole film 1. Optionally layer A comprises the totality of the microparticles, i.e. layer B does not comprise microparticles.

The variant of FIG. 2A is identical to that of FIG. 2, with the exception of the presence of a hydrophobic or super-hydrophobic layer C coated onto the surface of the heat-sealable layer A not directly adhered to the base layer B: thus in the case of FIG. 2A the first external surface 2 is defined (at least in part) by the hydrophobic or super-hydrophobic layer C, which is an outer coating. The coating of FIG. 2A is identical to that of FIG. 1A and thus not further described to avoid repetitions.

### The Multilayer Film of the Embodiments Shown in FIGS. 3 and 3A

A third embodiment of a multilayer film 1 according to aspects the invention is shown in FIG. 3. Also the multilayer film 1 of FIG. 3 is designed for packaging applications and particularly configured for vacuum packaging. In accordance with an aspect, the multilayer film 1 may be used for vacuum skin packaging.

The multilayer film 1 has a first external surface 2 and a second external surface 3 opposite to the first external surface 2. In practice, the first external surface 2 is destined to form an inner surface of a package, for example of a vacuum package, obtainable with the multilayer film 1: in other words, the first external surface 2 of the multilayer film 1 is destined to contact a product hosted in the vacuum package obtainable with film 1, while the second external surface 3 is destined to define part or the entirety of the outer anti-abuse surface of the package.

The multilayer packaging film 1 comprises:
an outer thermoplastic heat-sealable layer A,
a thermoplastic mono layer B directly adhered to layer A.

In the embodiment of FIG. 3 the heat sealable layer A and the base layer B are both a monolayer. Thus, base layer B and heat sealable layer A are both outer layers. On the other hand, as described below in connection with other embodiments of the invention, nothing excludes that base layer B may present a multilayer structure.

In greater detail, the base layer B of film 1 has one of its principal surfaces defining the second external surface 3, while the other of the principal surfaces (indicated with reference numeral 4) of the base layer B is directly adhered to one of the principal surfaces (indicated with reference numeral 5) of the heat-sealable layer A. On its turn, heat-sealable layer A has the other principal surface defining the first external surface 2 of the film 1.

As it may be seen from FIG. 1 microparticles 6 are incorporated in the support layer forming the mono-layer base layer B. The microparticles 6 are sized and positioned such that one or more regions of the first external surface 2 of the multilayer film present a Mean Roughness Depth (Rz) of at least 4.5 μm, measured according to ISO4287.

In the embodiment of FIG. 3 the entire first external surface 2 of the multilayer film has a Mean Roughness Depth (Rz) of at least 4.5 μm, measured according to ISO4287.

In an aspect, one or more regions of the first external surface 2 of the multilayer film 1 of FIG. 3, for example the entire first external surface 2, may present a Mean Roughness Depth (Rz) of at least 5.0 μm, measured according to ISO4287.

From a structural point of view, the microparticles 6 of the film 1 of FIG. 3 are spherical. On the other hand, the microparticles may alternatively take other shapes such as spheroid or ovoid or teardrop shaped. The microparticles 6 may be hollow or non-hollow, non-hollow microparticles being a currently preferred option. The microparticles 6 may have an average particle diameter comprised between 10 and 110 μm, optionally between 20 and 100 μm, more optionally between 30 and 90 μm.

The microparticles 6 used in the embodiment of FIG. 3 are non-hollow spherical microparticles presenting an average particle diameter from 10 to 110 μm, optionally from 20 to 100 μm, more optionally from 30 to 90 μm. As indicated above also non-spherical particles may be used although shapes close to the spherical shape and deprived of sharped or pointed shapes are currently considered preferred. In term of volumes, the spherical or non-spherical microparticles present a particle volume from 5.2·10² μm³ to 7.0·10⁵ μm³, optionally from 4.1·10³ μm³ to 5.2·10⁵ μm³, more optionally from 1.4·10⁴ μm³ to 3.8·10⁵ μm³.

In the third embodiment of FIG. 3 the microparticles are fully incorporated in the base layer B: in other words, each of said microparticles is entirely embedded in thermoplastic material forming the base layer B. In greater detail, the microparticles embedded in the base layer B are present in amount of at least 5% by weight calculated in respect of the total weight of the same base layer B.

Higher amounts of microparticles may be desirable: for example the microparticles in the base layer B may in amount which is:
from 5% to 60% by weight calculated in respect of the total weight of said base layer B, or
from 15% to 55% by weight calculated in respect of the total weight of said base layer B, or
from 25% to 50% by weight calculated in respect of the total weight of said base layer B.

Although presence of microparticles also in layer A is not excluded, in this example layer B of the embodiments of FIGS. 3 and 3A (i.e. support layer b) comprises a major proportion of the total amount of microparticles present in the whole film 1, optionally an amount of more than 60 wt %, more than 70 wt %, more than 80 wt %, more than 90 wt %, more than 95 wt %, more than 99 wt % of the total amount of microparticles present in the whole film 1. In the examples shown in FIGS. 3 and 3A support layer b comprises the totality of the microparticles, i.e. layer A does not comprise microparticles.

Possible materials for the microparticles are indicated in below dedicated section MATERIALS FOR THE MICROPARTICLES.

In the example of FIG. 3, the heat sealable layer A directly adhered to the base layer B has no microparticles 6 therein and presents a thickness sensibly smaller than that of the base layer B which incorporates microparticles. In greater detail, it is noted that the heat sealable layer A has an average thickness below 10 μm, optionally from 1 to 5 μm. The mono base layer B consists of support layer b directly adhered to the heat sealable layer and has average thickness from 15 to 80 μm, optionally from 20 to 70 μm, for example from 30 to 70 μm.

As to the microparticles 6, they have a particle size or average particle diameter of at least 20%, optionally at least 30%, more optionally at least 50%, greater than the average thickness of the mono base layer B in which the microparticles are incorporated.

In term of materials, it is noted that the heat sealable layer A and the base layer B of the multilayer film 1, with the exception of the microparticles, are formed from one or more thermoplastic materials. Details of the materials for each one of the layers A and B are reported in below dedicated sections (MATERIALS FOR HEAT SEALABLE LAYER A, MATERIALS FOR BASE LAYER B).

In a currently preferred version of the film of FIG. 3, the microparticles are only present in the base layer B (which is a mono layer formed by support layer b only), and are absent from the heat sealable layer A. The microparticles are spherical, non-hollow, present a diameter from 30 to 90 μm and are present in the base layer in an amount from 25% to 40% by weight calculated in respect of the total weight of said base layer. Furthermore, the heat sealable layer A has an average thickness from 1 to 5 μm and the mono base layer B consists of support layer b directly adhered to the heat sealable layer and having average thickness from 20 to 70 μm. Furthermore, the first external surface 2 of film 1 has

Mean Roughness Depth (Rz) greater than 5 μm, while the second external surface 3 of film 1 is smooth or presents a Mean Roughness Depth (Rz) less than 1.5 μm (Rz being measured according to ISO4287).

In a way similar to what disclosed in FIGS. 5 and 6 (which refer to the case of FIG. 1 with particles in the seal layer, but which may also represent the surface pattern obtainable with the alternative of FIG. 3) the first external surface 2 of the film 1 of FIG. 3, by virtue of the presence of the microparticles in the base layer B and by virtue of the reduced thickness of the seal layer A, is a patterned surface(s) comprising a substantially smooth (and flat) base surface, in those areas 2a where the first external surface 2 has no underlying microparticles, and micro-protrusions emerging relative to the base surface in those areas 2b where the first surface 2 has underlying microparticles: also in the example of FIG. 3, the distance (h) between crests of the micro-protrusions and the base surface (again with the film 1 resting on a flat surface for the purpose of the measure) is comprised between 30 and 100 μm, optionally between 40 and 80 μm.

Finally, it is noted that in the multilayer film 1 of FIG. 3 the heat-sealable layer A has a free and not further coated surface defining the first external surface 2 destined to contact the product.

The variant of FIG. 3A is identical to that of FIG. 3, with the exception of the presence of a hydrophobic or super-hydrophobic layer C coated onto the surface of the heat-sealable layer A not directly adhered to the base layer B: thus in the case of FIG. 3A the first external surface 2 is defined (at least in part) by the hydrophobic or super-hydrophobic layer C, which is an outer coating. The coating of FIG. 3A is identical to that of FIG. 1A and thus not further described to avoid repetitions.

### The Multilayer Film of the Embodiments Shown in FIGS. 4 and 4A

A fourth embodiment of a multilayer film 1 according to aspects the invention is shown in FIG. 4. Also the multilayer film 1 of FIG. 4 is designed for packaging applications and particularly configured for vacuum packaging. In accordance with an aspect, the multilayer film 1 may be used for vacuum skin packaging.

The multilayer film 1 has a first external surface 2 and a second external surface 3 opposite to the first external surface 2. In practice, the first external surface 2 is destined to form an inner surface of a package, for example of a vacuum package, obtainable with the multilayer film 1: in other words, the first external surface 2 of the multilayer film 1 is destined to contact a product hosted in the vacuum package obtainable with film 1, while the second external surface 3 is destined to define part or the entirety of the outer anti-abuse surface of the package.

The multilayer packaging film 1 comprises:
an outer thermoplastic heat-sealable layer A,
a thermoplastic multilayer base layer B directly adhered to layer A.

In the embodiment of FIG. 4 the heat sealable layer A does not comprise microparticles 6 and is identical to that of FIG. 3 (and thus not further described), whilst and the base layer B is multilayer. In detail, the base layer B is multilayer having a support layer b directly adhered to the heat-sealable layer A: the support layer b contains the microparticles 6 and is identical to the support layer b of the monolayer base layer B of the example of FIG. 3 (and thus also not further described to avoid repetitions).

Different from FIG. 3, the multilayer base layer B of the film of FIG. 4 includes an outermost anti-abuse layer 7 and an inner gas barrier layer 8: of course further inner layers may be present depending upon the intended application of film 1.

Optionally, micro-particles may be present in said other inner film layers (in addition to those present in support layer b) although in a currently preferred solution no microparticles are incorporated into the barrier layer 8 to avoid damages to its gas barrier properties.

The support layer b which is directly adhered to layer A comprises a major proportion of the total amount of microparticles present in the whole film 1, optionally an amount of more than 60 wt %, more than 70 wt %, more than 80 wt %, more than 90 wt %, more than 95 wt %, more than 99 wt % of the total amount of microparticles present in the whole film 1. Optionally support layer b comprises the totality of the microparticles, i.e. layer A does not comprise microparticles.

The variant of FIG. 4A is identical to that of FIG. 4, with the exception of the presence of a hydrophobic or super-hydrophobic layer C coated onto the surface of the heat-sealable layer A not directly adhered to the base layer B: thus in the case of FIG. 4A the first external surface 2 is defined (at least in part) by the hydrophobic or super-hydrophobic layer C, which is an outer coating. The coating of FIG. 4A is identical to that of FIG. 1A and thus not further described to avoid repetitions.

The multilayer film 1 of the above embodiments of FIGS. 1, 2, 3 and 4 and related variants of figures of FIGS. 1A, 2A, 3A and 4A is obtained by co-extrusion (which in the meaning of the present specification also covers extrusion coating) wherein at least the thermoplastic heat sealable layer A, the support layer b of the thermoplastic base layer B and, optionally, the other layers of the thermoplastic base layer are co-extruded and wherein the microparticles 6 are directly embedded at least into one or both of the support layer b of the thermoplastic base layer B and the heat sealable layer A during the co-extrusion process, such that the surface pattern and roughness of the first external surface 2 is directly achieved with co-extrusion of the various layers forming the film 1, with no need of further operations. Accordingly, the first external surface 2 does not need to be subjected to any particular treatment to gain roughness. The overall thickness of the film may vary depending upon the embodiments and in particular upon the number and thickness of the layers forming the film 1: in general, the multilayer film 1 has a total thickness ranging from 5 to 250 microns, optionally from 10 to 200 microns.

### Materials for Heat Sealable Layer A

In accordance with an aspect, the heat-sealable layer A of the films 1 in accordance with the embodiments described above may comprise a major amount of a polymer selected among ethylene-vinyl acetate copolymers (EVA), polyethylenes, homogeneous or heterogeneous, linear ethylene-alpha-olefin copolymers, polypropylene copolymers (PP), ethylene-propylene copolymers (EPC), acrylates and methacrylates, ionomers, polyesters, polyamides and their blends.

In a further aspect, the heat-sealable layer A comprises more than 60%, 70%, 80%, 90%, or 95% by weight, with respect to the weight of the same layer, of one or more of said polymers; optionally the heat sealable layer A substantially consists, of one or more of said polymers.

EVA is a copolymer formed from ethylene and vinyl acetate monomers wherein the ethylene units are present in a major amount and the vinyl-acetate units are present in a minor amount. The typical amount of vinyl-acetate may range from about 5 to about 20%.

Preferred polymers for the heat-sealable layer A are heterogeneous materials as linear low density polyethylene (LLDPE) with a density usually in the range of from about 0.910 g/cc to about 0.930 g/cc, linear medium density polyethylene (LMDPE) with a density usually in the range of from about 0.930 g/cc to about 0.945 g/cc, and very low and ultra-low density polyethylene (VLDPE and ULDPE) with a density lower than about 0.915 g/cc; and homogeneous polymers such as metallocene-catalyzed EXACT™ and EXCEED™ homogeneous resins obtainable from Exxon, single-site AFFINITY™ resins obtainable from Dow, QUEO by Borealis, TAFMER™ homogeneous ethylene-alpha-olefin copolymer resins obtainable from Mitsui. All these materials generally include co-polymers of ethylene with one or more co-monomers selected from (C4-C10)-alpha-olefin such as butene-1, hexene-1, octene-1, etc., in which the molecules of the copolymers comprise long chains with relatively few side chain branches or cross-linked structures.

These polymers can be advantageously blended in various percentages to tailor the sealing properties of the films depending on their use in packaging, as well known by those skilled in the art.

In a currently preferred embodiment, the heat-sealable layer A consists of blends of LLDPE and metallocene-PE resins.

Optionally, the resins for the heat-sealable layer A have a seal initiation temperature lower than 110° C., more optionally lower than 105° C., and yet more optionally lower than 100° C.

### Materials for Base Layer B

In the embodiment of FIG. 1 and FIG. 3, the base layer B consists of a single layer also herein indicated as support layer b. The monolayer base layer B comprises one or more thermoplastic resins commonly used in the manufacture of packaging films.

For example, in the first embodiment of the film 1 the monolayer base layer B comprises a major proportion of, optionally consists of, one or more thermoplastic resins selected from polyethylenes, polypropylenes, ethylene vinyl acetates (EVAs), ionomers, polyamides, polyesters, optionally blended with adhesive resins, such as anhydride-modified polyolefins, in order to improve the adhesion to the heat-sealable layer.

When the base layer B is multilayer, the support layer b directly adhered to layer A may be the same as monolayer base layer B and will not be further described to avoid repetitions.

### Materials for Gas Barrier Layer

The multilayer base layer B may comprise an inner gas barrier layer.

In an embodiment, the inner gas barrier layer may comprise a major proportion of, optionally may consist of, one or more polymers selected among ethylene/vinyl alcohol copolymers (EVOH), polyester homopolymers and copolymers, polyamide homopolymers and copolymers, polyvinyl alcohol copolymers (PV/A), polyvinyl chlorides (PVC), polyvinylidene chloride (co) polymers (PVDC) and their blends.

With polyvinylidene chloride (co) polymers, homopolymers of vinylidene chloride or its copolymers with other suitable monomers in minor amount are meant, such as vinylidene chloride/methyl acrylate copolymers (PVDC/MA), vinylidene chloride-vinyl chloride copolymers (PVDC/VC), vinylidene chloride-acrylonitrile copolymers and vinylidene chloride-methyl acrylate-vinyl chloride terpolymers. Especially preferred copolymers are vinylidene chloride/methyl acrylate copolymers (PVDC/MA). In an embodiment, the inner barrier layer may comprise a major proportion, optionally at least 70%, at least 80%, at least 90%, at least 95% by weight, or may consist of EVOH, optionally in admixture with one or more of the above polymers, more optionally in admixture with polyamides.

In another embodiment, the inner barrier layer may comprise a major proportion, optionally at least 70%, at least 80%, at least 90%, at least 95% by weight, or may consist of polyamides, optionally in admixture with one or more of the above polymers, more optionally in admixture with EVOH or polyesters.

In another embodiment, the inner barrier layer may comprise a major proportion, optionally at least 70%, at least 80%, at least 90%, at least 95% by weight, or may consist of one or more polyester(s), for example polyethylene terephtalate (PET), optionally in admixture with one or more of the above polymers.

In an option, the films comprise only one internal gas barrier layer, but multiple gas barrier layers may also be present.

### Materials for the Outer, Anti-Abuse Layer

The multilayer base layer B may comprise an outer, anti-abuse (or “skin”) layer.

The polymer(s) for the outer anti-abuse layer is generally selected based on its heat resistance during the sealing step. In fact, it may be advantageous that the polymer of this layer has a melting point higher than the melting point of the polymer of the heat-sealable layer A.

The outer anti-abuse layer may comprise a major proportion of, optionally may consist of, a polymer selected among polyolefins, ethylene-vinyl acetate copolymers, ionomers, (meth)acrylates copolymers, polyamides, polyesters and their blends.

Optionally, the surface of the outer anti-abuse layer not adhered to an inner layer may be superficially treated and/or coated in order to modify its surface properties. As an example, such surface may be corona-treated to improve surface printing.

### Materials for Other Layers

The multilayer base layer B may comprise one or more inner tie layers. Tie layers have the main function of improving adhesion between the layers.

The tie layers may comprise a major proportion of, optionally may consist of, one or more adhesive polymers selected among polyolefins and modified polyolefins.

Specific, not limitative, examples of adhesive polymers include ethylene-vinyl acetate copolymers, ethylene-(meth)acrylate copolymers, ethylene-alpha-olefin copolymers, any of the above modified with carboxylic or anhydride functionalities, elastomers, and blends thereof. The tie layers may have a typical thickness from 2 to 15 microns, preferably from 3 to 10 microns.

The multilayer base layer B may comprise one or more inner bulk layers. The bulk layers may comprise a major proportion of, optionally may consists of, one or more polymers selected among EVA, acrylate based resins, ionomers, polyolefins, modified polyolefins and their admixtures.

Preferably, the overall thickness of the one or more bulk layers (H) is lower than 60%, optionally lower than 40% and/or higher than 10%, more optionally higher than 20% with respect to the total film thickness.

### Additives

The layers of the present film may contain one or more additives typically included in such polymer compositions.

These additives include slip and anti-block agents such as talc, waxes, silica, and the like, antioxidants, stabilizers, plasticizers, fillers, pigments and dyes, cross-linking inhibitors, cross-linking enhancers, UV absorbers, odour absorbers, oxygen scavengers, antistatic agents, anti-fog agents or compositions, and the like. All these additives are well known and may be present in one or more layers of the film in appropriate amounts, known to those skilled in the art of packaging films.

### Materials for Super-Hydrophobic Layer C

The coating layer C may be a super-hydrophobic layer which comprises one or more organic or inorganic hydrophobic components selected among fluoropolymers, polysiloxanes, hydrophobic nanoparticles, for example hydrophobic oxide nanoparticles such as silica and silica precursors as tetraethyl orthosilicate (TEOS) and the like, or super-hydrophobic waxes.

In an example, the coating layer C may include hydrophobic oxide nanoparticles, more optionally hydrophobic oxide nanoparticles selected among silica (silicon dioxide), alumina, magnesium oxide, titania and their admixtures.

In a currently preferred solution coating C is an inorganic coating, namely a coating comprising major amount of inorganic elements and not including major amount of organic compounds, oligomers, cross-linked or cured polymers, organic networks and the like. For example, the coating C may not comprise organic compounds, oligomers, cross-linked or cured polymers or organic networks.

The hydrophobic oxide nanoparticles are not especially limited as long as they have hydrophobic properties. Accordingly, they may be particles made hydrophobic by suitable surface treatments, such as reactions with silane coupling agents.

Examples of suitable oxides are silica (silicon dioxide), alumina, magnesium oxide, titania or the like, and their admixtures.

Examples of silica include the products Aerosil R972, Aerosil R972V, Aerosil R972CF, Aerosil R974, Aerosil RX200 and Aerosil RY200 (Japan Aerosil) and Aerosil R202, Aerosil R805, Aerosil R812 and Aerosil R812S (Evonik Degussa). Examples of titania include the product Aeroxide TiO2 T805 (Evonik Degussa) and the like.

Examples of alumina include fine particles such as Aeroxide Alu C (Evonik Degussa) made hydrophobic by surface treatment with a silane coupling agent.

In a currently preferred option, the hydrophobic oxide is silica, as such or as silica precursor, for instance tetraethyl orthosilicate (TEOS) and the like.

In a currently preferred option, highly hydrophobic silica particles having surface trimethylsilyl groups are used.

The coating layer C may additionally comprise other inorganic elements such as zinc and/or magnesium.

### Materials for the Microparticles

The microparticles 6 described in the above embodiments may be made in any suitable sufficiently rigid material and configured in any suitable shape such as to be resistant to extrusion. In an option, the microparticles are solid (i.e. not hollow or porous) microparticles, as they are more resistant to the extrusion conditions and provide a better surface roughness.

The microparticles may comprise an organic component and/or an inorganic component. The organic component may be selected, for instance, among acrylic resin, urethane resin, melamine resin, amino resin, epoxy resin, polyethylene resin, pol-ystyrene resin, polypropylene resin, polyester resin, cellulose resin, vinyl chloride resin, polyvinyl alcohol, ethylene-vinylacetate copolymer, ethylene-vinyl alcohol copolymer, ethylene-ethyl acrylate copolymer, polyacrylonitrile or polyamide. The inorganic component may be selected, for instance, among aluminum, copper, iron, titanium, silver, calcium and other metals or alloys or intermetallic compounds containing these, silicon oxide, aluminum oxide, zirconium oxide, titanium oxide, iron oxide and other oxides, calcium phosphate, calcium stearate and other inorganic acid salts or organic acid salts, glass and aluminum nitride, boron nitride, silicon carbide, silicon nitride and other ceramics.

For example, the microparticles 6 may be: acrylic microparticles, silica microparticles, boron silicate microparticles, calcium phosphate microparticles, calcium stearate microparticles, glass microparticles and charcoal powder microparticles. In accordance with a currently preferred solution, the micro-particles are selected from acrylic micro-particles and glass micro-particles.

Suitable micro-particles are for instance microbeads of acrylates such as Altuglas B100 (average particle size 30 microns) and Altuglas B130 (average particle size of 20 microns) from Arkema, solid glass micro-particles such as Spheriglass 2530 (average particle size of 65 microns), Spheriglass 3000 (average particle size of 35 microns), hollow glass microbeads such as Sphericel® 60P18 (average particle size of 20 microns) from Potters Industries, Eccospheres® SID230Z (average particle size of 55 microns) from Trelleborg or boron silicate microbeads such as iM30K from 3M (average particle size of 18 microns).

### Process of Manufacturing the Multilayer Film

The multilayer film 1 herein claimed and more specifically the multilayer film according to the above embodiments may be manufactured by co-extrusion or extrusion coating, using either a round or a flat film die that allows shaping the polymer melt into a tubing or a flat film respectively.

In greater detail, FIG. 7 schematically shows an extrusion plant 10 comprising a first extruder 11 and a second extruder 12 leading to a flat film die 13 which is thus provided with a flat forming slit 14 (once again the shape of the forming slit in the die 13 may for example be round or may take other shapes depending upon the applications). In the case of FIG. 7, the thermoplastic heat-sealable layer A is co-extruded with the thermoplastic monolayer b forming the base layer B (in case the base layer B is a mono-layer) or with at least the support layer b of the multilayer base layer B. Although, FIG. 7 shows an example where heat sealable layer A and a single layer of base layer B are coextruded, it is possible to envisage a co-extrusion line designed for films where the base layer B is multilayered (as shown for example in the embodiments FIGS. 2 and 4): in this case each one of the multiple layers of the base layer would be processed in parallel in a respective extruder forcing polymer material of each layer to and through the die 13 where the plurality of films would be adhered to each other.

As shown in FIG. 7, thermoplastic polymer material P1 used for heat-sealable layer A is fed to the first extruder 11 via a supply device such as for example a feed hopper 15. Furthermore, thermoplastic polymer material P2 used for the base layer B (in FIG. 7 for the mono-layer base layer B) is fed to the second extruder 12 via a further supply device such as for example a further feed hopper 16. At least one extruder mixer, such as an extruder screw 17, 18, operates in each one of the first and second extruders 11, 12 and conveys the respective polymer material towards die 13. The first and second extruders 11 and 12 respectively comprise a first and a second heater 19 and 20 configured to heat and melt the polymer materials P1 and P2 processed in the first and second extruders.

According to an aspect of the invention, microparticles 6 are mixed with the thermoplastic polymer material P2 used for extrusion of the monolayer b or of the support layer of multilayer base layer B directly adhered to heat-sealable layer A, alternatively, the microparticles 6 are mixed with the thermoplastic polymer material P1 used for extrusion of the heat-sealable layer A.

The microparticles 6 may be compounded with a carrier resin to give a masterbatch which is then extruded with thermoplastic polymer material P1 and/or P2. Alternatively, the microparticles 6 may be dry blended with the respective thermoplastic polymer material P1 and or P2, without previous compounding.

The thermoplastic materials P1 and P2 (at least one of which embeds the microparticles 6) are moved by the respective first and second extruders 11, 12 to the die 13 and form the multilayer film 1. The multilayer film 1 prepared by co-extrusion as disclosed above presents a first external surface 2 which is not smooth, but rather presents a pattern characterized by protuberances emerging in correspondence of the areas of base layer B or of heat-sealable layer A where the microparticles are embedded, for example defining one of the films 1 shown in FIGS. 1, 2, 3 and 4.

In accordance with an optional variant the surface of the heat-sealable layer A not directly adhered to the base layer B may be coated with further coating layer. In the examples of figures in FIGS. 1A, 2A, 3A and 4A the further coating layer is the hydrophobic or superhydrophobic layer C described above. Other types of coating could be envisaged.

To form the hydrophobic coating C, a hydrophobic coating composition C′ is applied to the rough surface of the heat sealable layer A not directly adhered to layer B by any standard coating method, such as for instance by gravure coating, smooth roll coating, direct gravure, reverse gravure, offset gravure, spray coating or dip coating. As an alternative, the coating C may be applied by vacuum deposition. In FIG. 7 a coating application station 21 configured for applying composition is schematically represented. Note the station 21 may be positioned in-line downstream the extrusion plant 10 or may be a separate station.

### Articles for Packaging

The multilayer film 1 described above may be used to form various articles of packaging, which are briefly described herein below.

The articles of packaging obtained using the multilayer film 1 may be configured to define or cooperate to define an inner volume: by inner volume it is intended the volume V where a product will be hosted when the article of packaging is used. Note the article of packaging may be used alone to form the final package or in combination with other items, such as other films or supports of materials different from that of film 1. As such the inner volume may be entirely defined by the article of packaging formed with film 1 or in part by film 1 and in part by other components. In any case the first external surface 2 of the multilayer film 1 is destined to directly face the inner volume and to come into contact with the product: thanks to the accentuated roughness of the first external surface 2 of film 1 even in presence of contact between the first external surface 2 and the external surface of the product or between the first external surface 2 of film 1 and a surface of the same or other films, micro-passages are present allowing escape of gas, thus facilitating vacuumization of the package formed using the mentioned articles.

For example film 1 may be used to form the following articles for packaging:
a seamless tubing 30 (see FIG. 8); the seamless tubing may be obtained by manufacturing, optionally by coextruding, the multilayer film 1 directly in tubular form; the first external surface 2 of the multilayer film 1 directly faces the inner volume V inside the seamless tubing; the seamless tubing 30 so obtained may be further processed to form packages for example in the form of bag or pouches; note that although the tubing 30 shown in FIG. 8 is represented with a substantially circular profile, it may of course be flattened assuming an oval or a lenticular profile or other shapes in case for example flat or thin pouches need to be manufactured from tubing 30;
a longitudinally sealed tubing 40 (see FIG. 9); the longitudinally sealed tubing 40 may be obtained from the multilayer film 1 which is co-extruded in the form of a flat film and then shaped in tubular form with opposed longitudinal borders 1a, 1b of the multilayer film sealed, optionally heat sealed, to each other to form the tubing; the first external surface 2 of the multilayer film directly faces the inner volume V inside the longitudinally sealed tubing; also the seamless tubing 40 may be further processed to form packages for example in the form of bag or pouches; note that although the tubing 40 shown in FIG. 9 is represented with a substantially circular profile, it may of course be flattened assuming an oval or a lenticular profile or other shapes in case for example flat or thin pouches need to be manufactured from tubing 40;
an almost tubular film structure 50 (see FIGS. 10 and 10A); the almost tubular film structure 50 may be obtained from the multilayer film 1 which is co-extruded in the form of a flat film 1 and then shaped in a substantially tubular form with opposed longitudinal borders of the multilayer film approached to each other to form a longitudinal opening 51 extending along the almost tubular film structure 50; note that although the almost tubular film shown in FIGS. 10 and 10A has a main body with a substantially circular profile, other shapes may be envisaged; for example, the almost tubular film structure may have a V-shaped profile or a W shaped profile. In any case the first external surface 2 of the multilayer film 1 directly faces the inner volume V inside the almost tubular film structure 50; also the almost tubular film structure 50 may be further processed to form packages for example in the form of bags or pouches;
a flexible container in the form of a pouch or a bag 60; the flexible container may also be in the form of a plurality of interconnected bags or pouches 60 (see FIG. 11): in other words the multilayer film may be appropriately formed into a bag or pouch, or may be assembled with other films or with other multilayer films 1 to form one or more pouches or bags; the first external surface 2 of the multilayer film used to form each bag or pouch directly faces the inner volume of the pouch or bag where the product P will be hosted;
a tray 70 (see FIG. 12); for example the multilayer film 1 may be thermoformed to form tray 70: the first external surface 2 of the multilayer film 1 forms part or the entirety of a top surface of the tray; in FIG. 12 it is shown an exemplifying tray 70 with a base wall, a side wall and a top flange: nothing excludes trays of different shapes, including flat trays;
a plurality of interconnected trays 80 (see FIG. 13); the interconnected trays may be obtained by thermoforming the multilayer film 1 such that the first external surface of the multilayer film forms part or the entirety of a top surface of the plurality of interconnected trays; also the interconnected trays of FIG. 13 may present a shape different from that shown;
a kit 90 of one or more trays 91 with a closure film 92; depending upon the alternatives both the tray(s) 91 and the closure film 92 may be made using film 1 (this alternative is shown in FIG. 14) or only the tray(s) may be made using multilayer film 1, or only the closure film 92 may be made using multilayer film 1; in any case, if the one or more trays 91 comprise or are formed from the multilayer film 1, the first external surface 2 of the multilayer film 1 forms part or the entirety of a top surface of the tray(s) 91 destined to be sealed to a bottom surface of the closure film 92; if also, or alternatively, the closure film 92 comprises or is formed from multilayer film 1 (for example from a second multilayer film 1) the first external surface of the second multilayer film forms part or the entirety of the bottom surface of the closure film 92 destined to be sealed to the top surface of the one or more trays 91.

Even if the multilayer film 1 described above is particularly configured for vacuum packaging, it can also be used for non-vacuum applications. This is the case, for example, of consumer-unit pouches filled with fluid products, which are emptied by the consumer by sucking the fluid product through a straw or a spout. Such pouches typically contain food or beverages, but may also be filled with pharmaceuticals such as cough syrups, fluid drug formulations, dietary supplements etc.

These pouches suffer from a similar problem as packages to be vacuumized: upon sucking, the two panels of the pouch tend to collapse against each other entrapping part of the fluid product in the bottom of the pouch and preventing it from flowing to the straw or the spout. This behavior is more evident with viscous fluids (e.g fluids with a viscosity higher than 100 mPa*s), such as fruit puree, smoothies etc. Under these circumstances, a mechanical manipulation from the user is needed to move the fluid product towards the straw/spout and effectively emptying the pouch. In the absence of such mechanical manipulation, emptying of the pouch results poor, and some product is wasted.

Thus, film 1 may be used to manufacture an article for packaging in the form of a pouch or a bag equipped with a spout or an accommodation for inserting a straw; the rough, first external surface 2 of the multilayer film 1 directly faces the inner volume of the pouch or bag, favoring the product evacuation.

In an embodiment, a hydrophobic or super-hydrophobic layer C may be present (at least in part) onto the first external surface 2 to further improve the emptying effectiveness of the pouch or bag.

In an embodiment, the multilayer packaging film 1 may comprise a thermoplastic multilayer base layer B, comprising at least an outermost anti-abuse layer 7 and an inner gas barrier layer 8. Further inner layers may also be present.

### Package

It is a further aspect of the invention a package or a set of packages 100 obtained using the multilayer film 1. For example, the package or packages 100 may be obtained using one of the articles for packaging 30, 40, 50, 60, 70, 80, 90 described above. Each package 100 has at least one product P housed in the seat or in the space defined inside the package(s). For example, the product P may be a food product such as a solid food product, a liquid food product, a gel food product, or a food product comprising a solid and/or a liquid and/or a gel portion. The package(s) 100 may be non-vacuum packages or vacuum packages and, in accordance with an option, vacuum skin packages. In particular, in accordance with an aspect, the package(s) are vacuumized and hermetically sealed, for example heat sealed, such that at least a portion of the first external surface 2 of the multilayer film 1 used for making the package 100 contacts the product P housed inside the package.

For example, as shown in in FIGS. 15 and 16, the package 100 is a vacuum package in the form of a vacuumized bag or pouch. The package 100 of FIGS. 15 and 16 is obtained from a single multilayer film (formed into a tubing such as a section of articles 30 or 40 described before); transverse seals, for example transverse heat seals, 102 define a hermetically closed inner space 103 where the product P is hosted. The first external surface 2 of the multilayer film 1 used to form the package 100 defines the inner surface of the bag or pouch delimiting space 103 and is in contact with the product P housed in the space 103. In the package shown in FIGS. 15 and 16 the first external surface 2 of the film 1 used to form the package also has portions (in the specific examples annular portions surrounding the product P) in mutual contact to each other.

In a variant, the package 100 of FIGS. 15 and 16 could be obtained using two (or more) films coupled together, optionally heat sealed together for example at the peripheral border(s) thereof, to form said bag or pouch. One or both the two films may be formed by a multilayer film 1 of the invention; if for example both films are multilayer films 1 of the invention, then the first external surface 2 of each multilayer films 1 used for forming the package 100 would define a respective portion of the inner surface of the bag or pouch delimiting space 103 and acting in contact with the product P (and possibly also a portion acting in contact with the first external surface of the other of the two multilayer films 1). In embodiments, the packages can be non-vacuumized bags or pouches. For example, a non-vacuumized package may be in the form of a pouch or a bag equipped with a spout or an accommodation for inserting a straw, and a fluid product.

Pouches or bags of this type may be obtained from a single multilayer film 1, formed into a tubing or a sheet and coupled or sealed, optionally heat sealed, for example at the peripheral border(s) thereof and around the spout or the accommodation for the straw. Alternatively, they may be obtained using two (or more) films coupled or sealed together, optionally heat sealed together, for example at the peripheral border(s) thereof and around the spout or the accommodation for the straw. One or both films may be formed by a multilayer film 1 of the invention. In any case, the first external surface 2 of the multilayer film(s) 1 used for forming the pouch or bag faces the inner volume of the pouch or bag in contact with the fluid product.

Advantageously, the fluid product may have a viscosity greater than 100 mPa*s. Fluid products with a viscosity below 100 mPa*s may generally easily be drawn through a spout or a straw incorporated into a pouch, but when viscosity is close to or beyond 100 mPa*s it becomes more difficult to void all the product before the panels of the pouch collapse and trap it in the lower portion of the pouch, requiring human mechanical action to move it upward towards the spout or the straw. In bags or pouches comprising the multilayer film 1, a passageway is created when the panels of the pouch collapse upon one another, which allows the fluid product, even with a viscosity above 100 mPa*s, to pass and reach the spout or the straw with continued suction.

Typically, the viscosity of the fluid product should not exceed 1000 mPa*s, as drawing such viscous products via suction would require an excessive effort. Thus, in embodiments, the fluid products may have a viscosity below 1000 mPa*s, preferably comprised between 100 mPa*s and 1000 mPa*s. Viscosity values are intended to be measured at room temperature (25° C.).

Examples of fluid products which can benefit from being packaged in bags or pouches comprising the multilayer film 1 may be fruit juices, fruit purees, applesauce, smoothies, yogurts, whole eggs, soups, baby foods, milk, coffee, soft drinks, energy drinks, and beverages in general, pharmaceuticals such as cough syrups, fluid drug formulations, dietary supplements.

In some embodiments, especially for packaging fluid products with viscosities in the upper portion of the indicated range, it may be advantageous that the first external surface 2 of the multilayer film(s) 1 used for forming the pouch or bag be coated with a hydrophobic or super-hydrophobic layer C to further improve the evacuation of the pouch or bag.

In the example of FIG. 17 the package 100 comprises a tray 110 and a top film 120 closing the tray; the tray 110 may be a flat tray or, as in the example shown, a tray with a base wall 111, a side wall 112 emerging from the base wall and optionally a peripheral flange 113 emerging from a top rim 112a of the side wall 112.

The tray of FIG. 17 may be formed using the multilayer film 1 of the invention: in a possible solution the tray may be formed appropriately shaping the film 1 by thermoforming. The first external surface 2 of the multilayer film 1 defines the top surface of the tray 110. One or more products is/are placed on the tray top surface and thus in contact with the said first external surface of the multilayer film 1. Top film 120 is sealed to the top surface of the tray to form with the tray a hermetically sealed package housing the one or more products. In accordance with an optional aspect, the package 100 of FIG. 17 may be a vacuum skin package wherein the top film 120 forms a skin on part of the product surface and on a portion of the tray top surface not occupied by the product P.

Furthermore, in accordance with a variant of the package 100 of FIG. 17 also the top film 120 may be formed by the multilayer film 1. In this case the top film is sealed to the top surface of the tray to form with the tray a hermetically sealed package, with the first external surface of the multilayer film forming the top film facing inside the package. In accordance with another alternative, the tray 110 may be any tray (for example a paper tray, an injection molded tray or a thermoformed tray not obtained using the multilayer film 1 of the invention) and only the top film 120 may be made from a multilayer film 1 of the invention applied to the tray 110 as described above for the package 100 of FIG. 17.

### Packaging Process

Several exemplifying processes of packaging using the multilayer film 1 or the article for packaging 30, 40, 50, 60, 70, 80, or 90 are disclosed below.

In accordance with certain general aspects, packaging processes disclosed herein comprise:
providing one of the articles for packaging disclosed above in a way to define an inner volume (or a plurality of inner volumes) where one or more products can be hosted, or
configuring one multilayer film 1 in a way to define an inner volume (or a plurality of inner volumes) where one or more products can be hosted, or
coupling one multilayer film 1 with a further film or support to define an inner volume (or a plurality of inner volumes) where one or more products can be hosted, or
coupling two or more multilayer films 1 to form an inner volume (or a plurality of inner volumes) where one or more products can be hosted.

The process also provides for placing one or more products, optionally food products, inside the mentioned inner volume(s): in this respect, as it will appear in the following detailed description of certain specific processes, either the volume or volumes are first formed and then the product or products placed therein or the volume or volumes are defined during or even after positioning of the product in proximity of the multilayer film 1 or one of articles article 30-90.

Once a product is placed in the respective volume, the process may provide for a step of evacuating gas from the inner volume; during gas evacuation, a portion of the first external surface 2 of the at least one multilayer film 1 adheres to the one or more products (i.e. contacts the external surface of one or more products contained in the volume), without blocking the passage of gas: rather, thanks to the presence of the microparticles within the multilayer film 1 which provide an extremely corrugated surface 2, micro-passages are defined between the first external surface and the product surface allowing gas to pass through and thus, facilitating gas evacuation. Note the multilayer film 1 used in the process may also adhere to another portion of the first external surface of the same film or to the external surface of another film or a support used to form the package still leaving micro-passages between the two contacting surfaces and thus facilitating the process of gas evacuation and avoiding or minimizing the problem of bubbles of gas remaining trapped in the package under formation.

Once gas evacuation is completed, it is possible to proceed with hermetically sealing, optionally heat sealing, portions of said multilayer film 1 or of said article 30-90 forming one or more vacuum packaged products.

In a currently preferred variant the step of hermetically sealing is obtain by heat sealing. In greater detail, depending upon the design of the package (which may for example use just one multilayer film 1 according to aspect of the invention or two multilayer films 1 or one multilayer film 1 shaped to define a tray) the step of heat sealing may comprise one of the following alternatives.
a) For example the bag or pouch 100 of FIGS. 15 and 16 may be obtained by heat sealing to each other one or more seal bands 102 of a same multilayer film 1; in detail, the bag or pouch may be obtained by appropriately bending or plying a same multilayer film 1 such that the first external surface 2 is directed towards the inside of the bag or pouch; before heat sealing said one or more seal bands, one or more portions of the first external surface 2 of the multilayer film 1 are brought into intimate contact with one or more other portions of the first external surface of the same multilayer film as well with the external surface of the product P, yet leaving micro-passages therebetween facilitating gas evacuation; micro-passages may be formed also at the one or more bands 102: of course once heat sealing takes place at the one or bands, the plastic material melts and the micro-passages at the seal bands are hermetically closed.
b) An alternative bag may be obtained by heat sealing one or more seal bands of a first multilayer film 1 with one or more seal bands of a second and distinct multilayer film 1, to form the bag or pouch with two multilayer films 1 coupled together such that the first external surface 2 of each film is directed towards the inside of the bag or pouch; before heat sealing said one or more seal bands, one or more portions of the first external surface of the first multilayer film are brought into intimate contact with one or more portions of the first external surface of the second multilayer film and with the product surface, yet leaving micro-passages therebetween facilitating gas evacuation; micro-passages may be formed also at the one or more bands: of course once heat sealing takes place at the one or bands, the plastic material melts and the micro-passages at the seal bands are hermetically closed.
c) Another alternative bag, may be obtained by heat sealing one or more seal bands of a multilayer film 1 and one or more seal bands of a further film (having structure different from multilayer film 1) for example again to form a bag or pouch obtained coupling the two distinct films (as under option b) but in this case one of the two films is not a multilayer film 1 according to the invention); again, the first external surface 2 of the multilayer film 1 used is directed towards the inside of the bag or pouch; before heat sealing said one or more seal bands, one or more portions of the first external surface of the multilayer film 1 are brought into intimate contact with one or more portions of the first external surface of the further film and with the product surface, yet leaving micro-passages therebetween facilitating gas evacuation; micro-passages may be formed also at the one or more bands: of course once heat sealing takes place at the one or bands, the plastic material melts and the micro-passages at the seal bands are hermetically closed.
d) Another alternative package, for example as the one of FIG. 17, may be obtained by heat sealing one or more seal bands of a multilayer film 1 and one or more seal bands of a generic tray 110 (not obtained from film 1) for example located at the flange 113 of the tray; before heat sealing said one or more seal bands, one or more portions of the first external surface 2 of the multilayer film 1 are brought into intimate contact with one or more portions of an external surface of the tray (e.g. the top surface of the tray flange) and with the product surface, yet leaving micro-passages therebetween facilitating gas evacuation; also in this case, micro-passages may be formed at the one or more bands: of course once heat sealing takes place at the one or bands, the plastic material melts and the micro-passages at the seal bands are hermetically closed.
e) Another alternative package (again reference is made to FIG. 17), may be obtained by heat sealing one or more seal bands of a tray obtained from multilayer film 1 (for example the tray seal bands extend at a flange of the tray) with one or more seal bands of a further film (different from film 1); before heat sealing said one or more seal bands, one or more portions of the first external surface of the multilayer film (for example of the top surface of the tray flange) are brought into intimate contact with one or more portions of the first external surface of the further film and with the product surface, yet leaving micro-passages therebetween facilitating gas evacuation; micro-passages may be formed also at the one or more bands: of course once heat sealing takes place at the one or bands, the plastic material melts and the micro-passages at the seal bands are hermetically closed.
f) A further alternative package (again reference is made to FIG. 17), may be obtained by heat sealing one or more seal bands of a tray obtained from a first multilayer film 1 (for example the tray seal bands extend at a flange of the tray) with one or more seal bands of a second multilayer film 1; before heat sealing said one or more seal bands, one or more portions of the first external surface of the first multilayer film (for example of the top flange of the tray) are brought into intimate contact with one or more portions of the first external surface of the second multilayer film, yet leaving micro-passages therebetween facilitating gas evacuation; the two films have also portions of the respective first external surfaces in contact with the product again leaving micro-passages therebetween for gas evacuation; note micro-passages may be formed also at the one or more bands: of course once heat sealing takes place at the one or bands, the plastic material melts and the micro-passages at the seal bands are hermetically closed.
g) A further alternative package, in the form of a pouch or bag, may be obtained by:
   combining two multilayer films 1 according to the invention to form a pouch or bag with seals on three sides while leaving an opening on one side, or
   by combining a multilayer film 1 according to the invention with a traditional film to form a pouch or bag with seals on three sides while leaving an opening on one side, or
   using one multilayer film 1 of the invention folded on one edge and seals on the other two sides again leaving an opening on one side.
   In any case the first external surface 2 of the multilayer film or films used to form the pouch or bag is directed towards the inside of the same bag or pouch. The surfaces of the two films used or of two portions of the same film are brought together upon evacuation, yet leaving micro-passages therebetween facilitating gas evacuation. Once evacuation is complete, a treatment gas is back-filled into the pouch or bag through the same or separate nozzle used for evacuation, and then closed by heat sealing whereby the plastic material melts and the micro-passages at the seal bands are hermetically closed. The micro-passages created by the film of this invention allow for a more complete evacuation and reduced residual oxygen level upon back-filling with a non-oxygen treatment gas for improved efficiency and improved preservation of the food/perishable product within.

Note that, according to a possible variant, during gas evacuation the at least one multilayer film may be draped down onto the product and form a plastic skin around the product or part of the product and, in case the package includes a support or tray, also onto part of a surface of a support or tray not occupied by the product thus forming a vacuum skin package.

After the above description of certain general aspects of the processes disclosed herein, here below a more detailed description is provided of several exemplifying processes using the multilayer films 1.

In accordance with a first example, (see FIG. 18) a packaging process provides for using an article for packaging in the form of seamless tubing 30 of FIG. 8, for example directly obtainable from extrusion of multilayer film 1 through a round die, or in the form of longitudinally sealed tubing 40 of FIG. 9 which may be obtained from extrusion of a flat multilayer film 1 then longitudinally sealed at opposite longitudinal borders thereof. The described process may for example be used to make the package of FIG. 15.

The tubular article 30, 40 made from multilayer film 1 is advanced according to step-by-step motion along a predetermined path, which may be for example a vertical or horizontal path. A transversal seal 102 (in the exemplified case a transversal heat seal) across the seamless tubing 30 or longitudinally sealed tubing 40 is formed at each step by a transverse sealing station 200 (for example comprising one or two movable heat bars, at least one of which is transversally movable relative to tubing 30 or 40) to define a seat or space 103 receiving a respective product P therein. While the article 30, 40 is being advanced, products may be located at different and spaced apart locations inside the inner volume of the tubular article and then the seats or spaces formed by consecutive transversal seals. Alternatively, at each step of advancement of the tubular article 30, 40, first a transversal seal is formed to define at least one receiving seat or space 103 and then the product P is positioned or poured into the receiving seat or space 103 (as in the case of a vertical machine for packaging particulate products, liquid product, gel products or mixtures thereof). The receiving seats or spaces 103 formed as described above present an opening 103a, for example an open end or a through hole formed through the wall of the article and communicating with the inside of the seat or space, such that gas may then be evacuated from the seat or space 103 via the opening 103a. Once gas is evacuated from the receiving seat or space the process provides a step of hermetically closing the evacuated open seat or space and forming a vacuumized closed package 100.

In the example shown in FIG. 18 the step of hermetically closing the package is achieved by forming a further transversal seal 102 (with the same or with a further sealing bar or heating bar 200): the further transversal seal (for example the further transversal heat seal) is spaced from the initial transversal seal and extends across the seamless tubing 30 or the longitudinally sealed tubing 40 hermetically closing the evacuated open seat or space 103 and forming the vacuumized closed package 100, which extends between the transversal seal and the further transversal seal and houses the product.

The above cycle is repeated at each advancement step of the tubular article 30, 40 forming a sequence of closed packages 100. If the packages are not separated during their formation (for example using a heating bar with a cutter) they may be separated from one another at a dedicated cutting station 201 comprising for example a blade synchronized with the advancement of the tubing 30, 40 and with the heat bar 200.

In a possible first variant of the above first example, also shown in FIG. 18 (see dashed lines), the process may use an article for packaging in the form of the almost tubular film structure 50 of FIG. 10. In this case, the process would work as described in connection with the first example, with the addition of a further step wherein an appropriate sealer 202 intervenes to hermetically seal the longitudinal opening 51 of almost tubular film structure 50: for example, sealer 202 may include heated seal rollers 203 (or heated belts or heating pads or other heating means suitable for the purpose of operating as described here) acting on longitudinal borders of the article 50 and heat sealing the longitudinal opening, thus forming a longitudinally sealed tubing 40. The longitudinally sealed tubing 40 may then be processed as described above with the first example of packaging process to form packages 100 shown in FIG. 18.

In a possible second variant of the first example, again referring to FIG. 18 (see dashed lines), the process may envisage to start from a multilayer film 1, for example from a flat multilayer film 1 and to advance it along a predetermined path then configuring the film 1 to first form an almost tubular film structure 50 and then a longitudinally sealed tubing 40. The process thus provides a step of configuring the multilayer film 1 according to an appropriate shape: for example, again with reference to FIG. 18, at a bending station 204 the film shape may be modified (by appropriate bending of the film 1 on itself) from a flat shape and configured according to the almost tubular structure 50 of desired profile shape (the profile shape of the almost tubular structure may be circular or oval or V shaped or W shaped or other depending upon the needs) with opposed longitudinal borders of the multilayer film 1 approached to each other defining a longitudinal opening 51 extending along the almost tubular film structure. In this configuration, the first external surface of the multilayer film directly faces the inner volume V inside the almost tubular film structure. Once the almost tubular film structure 50 is obtained, the process provides for hermetically sealing the longitudinal opening 51: as described in connection with the first variant of the first example, sealer 202 intervenes to hermetically seal the longitudinal opening 51: for example, sealer 202 may include heated seal rollers 203 (or heated belts or heating pads or other heating means suitable for the purpose of operating as described here) acting on longitudinal borders of the article 50 and heat sealing the longitudinal opening 51, thus forming a longitudinally sealed tubing 40. The longitudinally sealed tubing 40 may then be processed as described above in connection with the first example of packaging process.

According to an aspect, which may be applicable to any one of the processes of packaging described above, the step of evacuating gas may comprise positioning at least one suction nozzle 300 at the opening 102 of each bag or pouch 100 under formation (reference is made to FIG. 19); for example with reference to FIG. 18, a nozzle 300 may be inserted into the inner volume V of the tubular article 30 or 40 from an open side of the tubular article and may operate upstream (with respect to a direction of advancement of article 30, 40 along said predetermined path) of the transverse sealing station 200. In this way, while the bags or pouches 100 are being formed the nozzle 300 may have access to the inside of seat or space 103 of each bag or pouch through the opening 103a. In order to extract gas from each seat or space 103 a vacuum source (not shown), for example comprising one or more pumps, is connected to the at least one suction nozzle 300 which is thus capable of withdrawing gas from said seat or space 103 through a channel extending inside the least one suction nozzle. For this purpose, the at least one suction nozzle comprises a respective external nozzle surface 301 and one or more suction apertures 302 defined at said external nozzle surface: for example, a plurality of apertures 302 may be present on the external nozzle side surface and one or more apertures 302 may be present at the nozzle distal end; all apertures are connected to the inner channel and then to the vacuum source. During the step of evacuating gas, the first external surface 2 of the multilayer film 1 or of the article 30, 40 contacts the external nozzle surface 301 of the suction nozzle 300 yet leaving micro-passages between said first external surface 2 and the external nozzle surface 301 facilitating gas evacuation through said at least one suction nozzle via said suction apertures 302.

In accordance with an optional aspect shown in FIG. 19, the suction nozzle comprises a terminal large and thin portion having a thickness sensibly smaller than its width configured for insertion in a seat or space of flat or substantially flat packages, such as flat or substantially flat bags or pouches. The process may also comprise, once evacuation is complete, a further step of back-filling a treatment gas into the pouch or bag through the same nozzle 300 or through a separate nozzle; then the package is closed by heat sealing whereby the plastic material melts and the micro-passages at the seal band(s) are hermetically closed. The micro-passages created by the film of this invention allow for a more complete evacuation and reduced residual oxygen level upon back-filling with a non-oxygen treatment gas for improved efficiency and improved preservation of the food/perishable product within.

A second example of a process according to the invention is described below with reference to FIGS. 20 and 21. In accordance with this second exemplifying process, an article for packaging in the form of the almost tubular film structure 50 of FIG. 10 (which may for instance be obtained by appropriately curving on itself a flat multilayer film 1) is advanced along a predetermined path and transversal seals 402 are formed by a sealing station 401 (for example transversal heat seals 402 formed by a heat bar or other sealer) across the almost tubular film structure 50 to define consecutive seats or spaces 403: each seat or space 403 is provided with an open side 404 and a product, optionally a food product, is located in the seat or inner space 403: said in other words, a plurality of adjacent packages 405 with an open end or side 406 are formed.

For example, the products P may be positioned relative to article 50 before or while the transversal seals 402 are formed at a supply station (not shown) operative upstream the sealing station 401 shown in FIG. 20.

Then, the process provides for a step of moving the open packages 405 to a vacuumization station 400 and of inserting the open sides 404 of each seat or space (and thus the open ends 406 of each package) in a vacuum chamber 409 of the vacuumization station 400, which is positioned along said predetermined path, while keeping the part of each seat or space (and thus of each package) housing the product outside the vacuum chamber 409: for example the part of each package hosting the product may rest of the top surface 407 of a conveyor 408 (for example a conveyor belt) positioned adjacent to the vacuum chamber 409, this latter having an elongated conformation and an elongated slit 409a for receiving the terminal neck 410 of each package 405 such that the package opening at the package open side or end 406 is entirely hosted inside the vacuum chamber 409. The vacuum chamber 409 is connected with a vacuum source 411, such that as soon as the packages P have their respective open ends or sides inside the vacuum chamber 409 and while the conveyor 408 moves the packages P from an upstream end to a downstream end of the vacuumization station 400 a step of evacuating gas from the seats or spaces 403 via the open sides/end 406 inserted inside said vacuum chamber progressively takes place.

As the packages arrive at the downstream end of the vacuumization station 400, most of the gas inside each package has been removed and thus a step of forming a longitudinal seal (for example a band seal directed parallel to the direction of movement of the packages along the determined path); the longitudinal seal may be a longitudinal heat seal and may take place at a sealing unit 412, which may be positioned in line with the vacuumization station 400; the sealing unit 412 hermetically closes the open sides/end 406 of the evacuated seats or spaces, thus forming closed packages extending between consecutive transversal seals 402. Note the sealing unit 412 may comprise a heated roller or heated belts or heating pads other heating means suitable for the purpose of operating as described above. The process also comprises a step of separating the vacuumized and sealed packages from one another. Note that in principle the step of separating the packages from each other could take place before the final sealing of the packages and also before vacuumization or at a distinct station operative after sealing of the packages.

During the described process, the first external surface 2 of the multilayer film 1 forming the packages contacts the external surface of the product P: the surface roughness induced by the presence of the microparticles provides a non-smooth external surface 2, which also in case of contact with the product surface leaves micro-passages, between the two contacting surfaces, useful for improving gas evacuation.

A third example of a process according to the invention is described below with reference to FIG. 22. The process comprises providing a flexible container made from one of the multilayer films 1 described above. Alternatively, it is possible to use an article in the form of interconnected pouches or a bags 60 of the type shown in FIG. 11 (for example flat pouches or bags made or comprising a multilayer film 1 as described above), which may then be separated from each other before placing a product therein. In any case, the first external surface 2 of the multilayer film 1 used for making each pouch or bag directly faces the inner volume V of each pouch or bag.

After placing one or more products P, optionally food products, inside each pouch or bag 60, an open end 61 of the flexible container 60 is inserted inside a vacuum chamber 500, while keeping the part 62 of each flexible container housing the product P outside the vacuum chamber. By operating a vacuum source 501 (e.g., at least one vacuum pump) connected with the vacuum chamber, gas is evacuated from the volume 502 inside the vacuum chamber and thus from the inner volume V of the flexible container 60.

Once gas evacuation from the flexible container 60 has been completed, a sealer 503 such as a heat sealer (for example comprising one or more heat bars or one or more heat rollers or one or more heat pads or other heat sealing devices) is operated for forming a seal, optionally a heat seal, hermetically closing the open end 61 of the evacuated flexible container 60 thus forming a vacuum package.

Also in the third example, during the described process the first external surface 2 of the multilayer film 1 forming the flexible containers 60 contacts the external surface of the product P hosted therein: the surface roughness induced by the presence of the microparticles provides a non-smooth external surface 2, which also in case of contact with the product surface leaves micro-passages, between the two contacting surfaces, useful for improving gas evacuation.

A fourth example of a process according to the invention is described below with reference to FIG. 23. The process comprises providing a flexible container made from one of the multilayer films 1 described above. Alternatively, it is possible to use an article in the form of interconnected pouches or a bags 60 of the type shown in FIG. 11 (for example flat pouches or bags made or comprising a multilayer film 1 as described above), which may then be separated from each other before placing a product therein. In any case, the first external surface 2 of the multilayer film 1 used for making each pouch or bag directly faces the inner volume V of each pouch or bag. After placing one or more products P, optionally food products, inside each pouch or bag 60, this latter is inserted in a two-chamber vacuum device 600 comprising a first chamber 601 hosting an open end 61 of the flexible container and a second chamber 602 receiving the part 62 of each flexible container housing the one or more products, optionally food products. A wall 603 separates the first and the second chambers 601, 602: the wall has however a calibrated gap 604 through which the bag or pouch neck may pass. Note, the first chamber 601 and second chamber 602 are in fluid communication through gap 604. Dividing wall 603 separates the first and second chambers from one another, except for the gap. The calibrated gap size may optionally be adjusted by means of a manually or automated controlled movable wall portion 603a of wall 603.

The first chamber 601 may be provided with a pressure sensor 611 and the second chamber 602 may be provided with a pressure sensor 612. Both pressure sensors are connected to a control unit 610 and are configured to provide the control unit 610 with a respective control signal indicative of a corresponding pressure in the first and second chambers, respectively. The control unit is configured to receive the control signals from the pressure sensors 611, 612 and to process the signals in an evacuation process (e.g. involving controlling a vacuum pump 609 to supply a vacuum pressure and/or to increase or decrease the vacuum pressure).

The vacuum device 600 further comprises a vacuum pump 609 optionally with a control valve 608. The vacuum pump 609 and control valve 608 are connected to the first chamber 601 by a vacuum line 607 configured to evacuate the first chamber by putting the vacuum pump and the first chamber into fluid communication with one another. The vacuum pump 609 and the control valve 608 are connected to the control unit 610 and configured to receive control signals from the same control unit. The control unit 610 is configured to control one or more different components (e.g. pump 609, valve 608) based on an evacuation process and depending upon signals received from one or more different sensors (e.g. sensors 611, 612).

At least the second chamber 602 is configured to open and close in order to allow for the flexible container (such as a bag or pouch 60 containing a product P to be packaged) to be introduced into the second chamber for evacuation and for it to be removed from the second chamber after evacuation. In order to insert the flexible container, the second chamber is opened and the flexible container placed into the second chamber in a manner that allows for the neck 65 of the container 60 to be introduced/inserted into the gap 604 so as to have the flexible package open end 61 positioned in the first chamber 601. Finally, the second chamber 602 is closed again and the evacuation process can be started.

It is noted that the individual manner in which the flexible containers are placed into the first and second chambers and the individual mechanisms for opening/closing the first chamber and/or the second chamber may be selected based on the individual application and based on the properties of the flexible containers and/or of the products P.

Generally, the control unit 610 is configured to control the vacuum pump and/or the control valve in order to provide the first chamber with a vacuum pressure below an ambient pressure. The vacuum pressure typically ranges from about or slightly below ambient pressure (at the beginning of evacuation) to about 1 to 20 mbar (upon completion of evacuation). In some embodiments, the target vacuum pressure ranges from about 1 mbar to about 20 mbar, preferably from about 1 mbar to about 10 mbar.

The fluid flow from the second chamber to the first chamber substantially depends upon the pressure differential between the pressures in the two chambers, as well as on the properties of the gap 604 (e.g. size, shape).

In order to evacuate the flexible container, the vacuum pressure applied to the first chamber causes gas/air from the second chamber to be drawn through the gap 604 into the first chamber 601. At the same time, the vacuum pressure applied to the first chamber causes gas/air from inside the package to be drawn through the bag neck 605 into the first chamber 601.

The absolute pressure in the first chamber is lower than the absolute pressure in the second chamber. Further, the absolute pressure in the package is also lower than the absolute pressure in the second chamber because the bag neck extending into the first chamber provides for a fluid flow from the inside of the package into the first chamber, which is less restricted or offers less resistance in comparison to the fluid flow from the second chamber into the first chamber.

Further, gas/air is also pushed out from the package due to the pressure in the second chamber being higher than the pressure inside the package, thereby applying compressive forces on an external surface of the package.

Upon completion of the evacuation of the package a sealer 606 (e.g. sealing bars) can be controlled to seal the flexible, for example by heat-sealing.

Also in the fourth example, during the described process the first external surface 2 of the multilayer film 1 forming the flexible container contacts the external surface of the product P hosted therein: the surface roughness induced by the presence of the microparticles provides a non-smooth external surface 2, which also in case of contact with the product surface leaves micro-passages, between the two contacting surfaces, useful for improving gas evacuation.

A fifth example concerns a process of packaging operated by a packaging line 700, which is described below with reference to FIG. 26. The process comprises advancing a bottom film 1′ (which may be made by a multilayer film 1 according to one of the above described embodiments) along a predetermined path where a thermoforming station 701 and a packaging station 702 of the packaging line 700 are positioned.

The bottom film 1′ is received at the thermoforming station 701 which forms tray shaped elements 703 in the bottom film 1′: each tray shaped element defines at least one respective seat 704 for receiving a product P; the process provides then for positioning, at a product loading station 705, at least one respective product P in each one of the seats 704 of the tray shaped elements 703; at the same time, the process provides for advancing a top film 1″ (the top film may be made by a multilayer film 1 according to one of the above described embodiments) towards the packaging station 702 where consecutive portions of the top film 1″ and of the bottom film 1′ (this latter with the formed tray shaped elements 703 defined therein) are received.

At the packaging station 702 consecutive portions of the top film 1″ are aligned above corresponding portions of the bottom film 1′ having one or more tray shaped elements, and then gas is evacuated from the volume between said aligned portions of the top film and of the bottom film. This step takes place in a closed vacuum chamber 706 which is periodically opened to allow access of the portions of the top and bottom film which are moved with a step-by-step movement in synchrony with opening and closing of the vacuum chamber 706 of the packaging station 702. Then sealing, optionally heat sealing, of the aligned portions of the top film and of the bottom film takes place to form one or more vacuum packages 707.

Once the packages are formed they may be separated the one or from the other at a severing station 708. The separation step may alternatively take place in the vacuum chamber of the packaging station or at a dedicated station not part of packaging line 700.

Depending upon the alternatives either the bottom film 1′ or the top film 1″ or both is/are formed by/using a multilayer film 1 according to the embodiments disclosed. In case the bottom film 1′ is formed with multilayer film 1 the first external surface 2 of the multilayer film 1 used forms part or the entirety of a top surface of the bottom film; in case the multilayer film 1 is used for forming or is comprised in the top film 1″, then the multilayer film 1 first external surface 2 forms part or the entirety of a bottom surface of the same top film 1″.

A sixth example concerns a process of packaging operated by a packaging line 800, which is described below with reference to FIG. 24, showing a first variant, and FIG. 25, showing a second variant. The process of the first variant of FIG. 24 comprises advancing a one or more preformed trays 801 along a predetermined path towards a packaging station 804 of packaging line 800: for example the trays may be delivered by a tray loader 802 onto a conveyor 803 moving the trays towards the packaging station 804. The process provides for positioning at least one respective product P on or inside each one of the one or more trays: this may take place at a manual or automatically operated product loading station 805. At the same time, the process provides for advancing a top film 806 (the top film may be made by a multilayer film 1 according to one of the above described embodiments) towards the packaging station 804 where consecutive portions 806a of the top film are sealingly fixed to respective trays 801.

In detail at the packaging station the following steps take place:
at least one portion 806a of the top film 806 is aligned above one or more trays,
gas present in a volume between said portion 806a of the top film and the one or more trays 803 in the packaging station is evacuated,
said portion of the top film is sealed, and optionally heat sealed, to said one or more trays to form one or more vacuum skin packages 807.

Note the one or more trays 801 may be formed by or comprise a multilayer film 1 according to one of the above described embodiments: in this case the first external surface of the multilayer film forms part or the entirety of a top surface of the one or more trays.

Also or alternatively the top film may be formed or comprise a multilayer film 1 according to one of the above described embodiments: in this case the first external surface of the multilayer film forms part or the entirety of a bottom surface of the top film.

The process of the second variant of FIG. 25 is analogous to the process of FIG. 24, with the exception that the top film 806, instead of being fed as a continuous film to the packaging station, is cut into discrete portions 806a at a cutting station 808 operative upstream the packaging station 806 and then fed to the packaging station by a transfer device 809.

In the processes of the fifth and sixth examples, the first external surface 2 of the multilayer films 1 (which may be used for forming the tray-shaped elements 703 or the trays 801, and/or the top film 1″, 806) contacts the external surface of the product P hosted in the packages under formation: the surface roughness induced by the presence of the microparticles in the multilayer film(s) 1 provides a non-smooth external surface 2, which also in case of contact with the product surface (or in case of contact between the top film and the tray/tray-shaped elements) leaves micro-passages, between the two contacting surfaces, useful for improving gas evacuation.

In the case of bags/pouches which are not vacuumized, the packaging processes may comprise the steps of:
providing a pouch or a bag equipped with a spout or an accommodation for inserting a straw, as disclosed above, having an inner volume where one or more fluid products can be hosted;
providing one or more fluid products to be packaged;
filling the inner volume of said pouch or bag with said one or more fluid products,
hermetically sealing said bag or pouch, by sealing, optionally heat sealing, the multilayer film to the accommodation for inserting a straw and/or by applying a cap to the spout.

1. A multilayer film for packaging, the multilayer film having a first external surface destined to contact a product hosted in a package and a second external surface opposite to the first external surface,
wherein the multilayer film comprises:
a thermoplastic mono or multilayer base layer (B),
a thermoplastic heat-sealable layer (A) adhered to the base layer (B),
microparticles at least in part incorporated in at least one of said heat-sealable layer (A) and said mono or multilayer base layer (B),
and wherein one or more regions of said first external surface of the multilayer film present a Mean Roughness Depth (Rz) of at least 4.5 μm, measured according to ISO4287.

2. The multilayer film of claim 1, wherein
one or more regions of said first external surface of the multilayer film present a Mean Roughness Depth (Rz) of at least 5.0 μm, measured according to ISO4287; or
the entire first external surface of the multilayer film presents a Mean Roughness Depth (Rz) of at least 5.0 μm, measured according to ISO4287.

3. The multilayer film of claim 1, wherein
the microparticles are spherical or spheroid or ovoid or teardrop shaped microparticles, or wherein the microparticles are non-hollow spherical or spheroid or ovoid or teardrop shaped microparticles;
wherein the microparticles have an average particle diameter from 10 to 110 μm; and/or the microparticles present a particle volume from 5.2·10² μm³ to 7.0·10⁵ μm³,
the average particle diameter being the average of the diameters of 20 randomly-selected particles observed by scanning electron microscopy or the like, taking as the diameter (i) the particle diameter when the particles are spherical and (ii) the average of the longest dimension and shortest dimension when they are non-spherical.

4. The multilayer film of claim 1, wherein
the microparticles are incorporated in the heat-sealable layer (A), each of said microparticles being entirely embedded in thermoplastic material forming the heat-sealable layer (A) and/or wherein the microparticles are incorporated in the thermoplastic mono or multilayer base layer (B), each of said microparticles being entirely embedded in thermoplastic material forming the mono or multilayer base layer (B).

5. The multilayer film of claim 1, wherein
the microparticles in said heat-sealable layer (A) are in amount of at least 5% by weight calculated in respect of the total weight of said heat-sealable layer (A); and
wherein the microparticles in the heat-sealable layer (A) are in amount which is:
from 5% to 60% by weight calculated in respect of the total weight of said heat-sealable layer (A), or
from 15% to 55% by weight calculated in respect of the total weight of said heat-sealable layer (A), or
from 25% to 50% by weight calculated in respect of the total weight of said heat-sealable layer (A).

6. The multilayer film of claim 1, wherein
the mono or multilayer base layer (B) comprises no microparticles or microparticles in amount lower than 1% by weight calculated in respect of the total weight of said mono or multilayer base layer (B).

7. The multilayer film of claim 1, wherein the microparticles in the mono or multilayer base layer (B) are in amount of at least 5% by weight calculated in respect of the total weight of said mono or multilayer base layer (B);
wherein the microparticles in the mono or multilayer base layer (B) are in amount which is:
from 5% to 60% by weight calculated in respect of the total weight of said mono or multilayer base layer (B), or
from 15% to 55% by weight calculated in respect of the total weight of said mono or multilayer base layer (B), or
from 25% to 50% by weight calculated in respect of the total weight of said of said mono or multilayer base layer (B).

8. The multilayer film of claim 7, wherein the heat-sealable layer (A) comprises no microparticles or microparticles in amount lower than 1% by weight calculated in respect of the total weight of said heat-sealable layer (A).

9. The multilayer film of claim 1, wherein
the heat-sealable layer (A) has a free and not further coated surface, opposed to the mono or multilayer base layer (B), defining said first external surface destined to contact the product;
or wherein the surface of the heat-sealable layer (A) not directly adhered or opposed to the base layer (B) is coated with a hydrophobic or super-hydrophobic layer (C).

10. The multilayer film of claim 1,
wherein the microparticles have a particle size of at least 20%, greater than the average thickness of the layer of the film in which the microparticles are incorporated;
wherein, with the exception of the microparticles, the multilayer film consists of one or more thermoplastic materials, and
wherein the multilayer film has a total thickness from 5 to 250 microns.

11. The multilayer film of claim 1,
wherein:
the base layer (B) is monolayer formed by a support layer (b); or
the base layer (B) is multilayer having a support layer (b) directly adhered to the heat-sealable layer (A),
the base layer (B) comprises a support layer (b) adhered to the heat sealable layer (A) via interposition of a tie layer,
further wherein:
the heat sealable layer (A) has an average thickness from 1 to 30 μm and
the support layer (b) has average thickness from 3 to 80 μm;
in particular wherein either said support layer (b) or the heat-sealable layer (A) incorporate the microparticles.

12. The multilayer film of claim 11, wherein the heat-sealable layer (A) comprises a major proportion of a polymer selected among ethylene-vinyl acetate copolymers (EVA), polyethylenes, homogeneous or heterogeneous linear ethylene-alpha-olefin copolymers, polypropylene copolymers (PP), ethylene-propylene copolymers (EPC), acrylates, methacrylates, ionomers, polyesters, polyamides and their blends; and
said support layer (b) comprising a major proportion of one or more thermoplastic resins selected from polyethylenes, polypropylenes, ethylene vinyl acetates (EVAs), ionomers, polyamides, polyesters;
further wherein the microparticles are at least one among acrylic microparticles, silica microparticles, boron silicate microparticles, calcium phosphate microparticles, calcium stearate microparticles, glass microparticles and charcoal powders.

13. The multilayer film of claim 1,
wherein the thermoplastic heat sealable layer (A) and at least a/the support layer (b) of the thermoplastic mono or multilayer base layer (B) directly adhered to layer (A) are obtained by a co-extrusion process, wherein the microparticles are embedded into one or both the support layer (b) of the thermoplastic base layer (B) and the heat sealable layer (A) during the co-extrusion process.

14. The multilayer film of claim 1,
wherein said second external surface is smooth or presents a Mean Roughness Depth (Rz) less than 1.5 μm, measured according to ISO4287;
wherein said one or more regions of said first external surface of the multilayer film are patterned surface regions comprising:
a smooth base surface in areas where the first external surface has no underlying microparticles and
micro-protrusions emerging relative to the smooth base surface where the first surface has underlying microparticles;
and wherein the distance between crests of said micro-protrusions and the smooth base surface is comprised between 30 and 100 μm.

15. A process of manufacturing a multilayer film, the multilayer film having a first external surface destined to contact a product hosted in a package and a second external surface opposite to the first external surface,
wherein the multilayer film comprises:
a thermoplastic mono or multilayer base layer (B),
a thermoplastic heat-sealable layer (A) adhered to the base layer (B),
microparticles at least in part incorporated in at least one of said heat-sealable layer (A) and said mono or multilayer base layer (B),
and wherein one or more regions of said first external surface of the multilayer film present a Mean Roughness Depth (Rz) of at least 4.5 μm, measured according to ISO4287 the process comprising the steps of coextruding at least the thermoplastic heat-sealable layer (A) with the thermoplastic monolayer (B) or with at least the/a support layer (b) of the multilayer base layer (B) directly adhered to the heat-sealable layer (A).

16. The process of claim 15, wherein the thermoplastic heat-sealable layer (A) is co-extruded with the thermoplastic monolayer (B) or with at least the support layer (b) of the multilayer base layer (B) directly adhered to layer (A) using either a round or a flat die respectively shaping the polymer melt into a tubular or a flat film;
and wherein:
the microparticles are mixed with the thermoplastic polymer(s) used for extrusion of the monolayer (B) or of the support layer (b) of multilayer base layer (B) directly adhered to heat-sealable layer (A); and/or
the microparticles are mixed with the thermoplastic polymer(s) used for extrusion of the heat-sealable layer (A).

17. The process of claim 15 wherein the multilayer film forms an article for packaging, wherein the multilayer film is configured to define or cooperate to define a volume, in particular an inner volume, destined to receive at least one product,
wherein said first external surface of the multilayer film directly faces the volume, in particular the inner volume;
wherein the article for packaging presents at least one opening for introducing a product into the inner volume or into one or more seats or spaces of the inner volume;
further wherein the article is in a form selected among the following options:
a) a seamless tubing obtained by manufacturing with said first external surface of the multilayer film directly facing the inner volume inside the seamless tubing, or
b) a longitudinally sealed tubing obtained from the multilayer film which is shaped in tubular form with opposed longitudinal borders of the multilayer film sealed to each other to form the tubing, with said first external surface of the multilayer film directly facing the inner volume inside the longitudinally sealed tubing, or
c) an almost tubular film structure obtained from the multilayer film which is shaped in a substantially tubular form with opposed longitudinal borders of the multilayer film approached to each other to form a longitudinal opening extending along the almost tubular film structure, with said first external surface of the multilayer film directly facing the inner volume inside the almost tubular film structure, or
d) a flexible container formed from or comprising the multilayer film, in the form of a pouch or a bag, with said first external surface of the multilayer film directly facing the inner volume of the pouch or bag, or
e) a tray comprising or formed from the multilayer film, with said first external surface of the multilayer film forms part or the entirety of a top surface of the tray destined to delimit said volume, or
f) a plurality of interconnected trays comprising or formed from the multilayer film, with said first external surface of the multilayer film forming part or the entirety of a top surface of the plurality of interconnected trays destined to delimit respective volumes, or
g) a tray with a closure film, wherein the tray comprises or is formed from the multilayer film, with said first external surface of the multilayer film forming part or the entirety of a top surface of the tray destined to be sealed to a bottom surface of the closure film, or
h) a tray with a closure film, wherein the closure film comprises or is formed from the multilayer film, with said first external surface of the multilayer film forming a part or the entirety of a bottom surface of the closure film destined to be sealed to a top surface of the one or more trays, or
i) a tray with a closure film, wherein
the tray comprises or is formed from the multilayer film, and
the closure film comprises or is formed from a second multilayer film,
the first external surface of the first multilayer film forms part or the entirety of a top surface of the tray destined to be sealed to a bottom surface of the closure film, and
the first external surface of the second multilayer film forms part or the entirety of the bottom surface of the closure film destined to be sealed to the top surface of the tray.

18. The article for packaging of claim 17, wherein said article for packaging is in the form of a pouch or a bag formed from or comprising the multilayer film, with said first external surface of the multilayer film directly facing the inner volume of the pouch or bag, said pouch or bag being equipped with a spout or an accommodation for inserting a straw.

19. A vacuum package comprising:
a multilayer film having a first external surface destined to contact a product hosted in a package and a second external surface opposite to the first external surface,
wherein the multilayer film comprises:
a thermoplastic mono or multilayer base layer (B),
a thermoplastic heat-sealable layer (A) adhered to the base layer (B),
microparticles at least in part incorporated in at least one of said heat-sealable layer (A) and said mono or multilayer base layer (B),
and wherein one or more regions of said first external surface of the multilayer film present a Mean Roughness Depth (Rz) of at least 4.5 μm, measured according to ISO4287
a product,
wherein the package is vacuumized and hermetically sealed, with at least a portion of the first external surface of said multilayer film or article for packaging contacting the product housed inside the package.

20. The vacuum package of claim 19 comprising one or more seats or spaces, wherein the product is housed in each one of said one or more seats or spaces, wherein said one or more seats or spaces are vacuumized and hermetically sealed with said at least a portion of the first external surface of the multilayer film contacting the product;
further wherein:
the vacuum package is in the form of a bag or pouch entirely formed by a single multilayer film, wherein said first external surface of the multilayer film forms at least a portion of the inner surface of the bag or pouch delimiting one or more spaces, and is in contact with the product housed in the one or more spaces and/or with the first external surface of the same multilayer film; or
the vacuum package is in the form of a bag or pouch comprising or consisting of two or more films coupled together to form said bag or pouch, wherein at least one of the two or more films is the multilayer film, wherein the first external surface of said at least one multilayer film forms at least a portion of the inner surface of the bag or pouch, of the inner surface of the bag or pouch delimiting one or more spaces, and is in contact with the product housed in the one or more spaces and/or with the first external surface of the same multilayer film or with the surface of another of said the two or more films; or
the vacuum package comprises
a tray, which is either a flat tray or a tray with a base wall and a side wall emerging from the base wall, wherein the tray comprises said multilayer film whose first external surface forms the top surface of the tray,
the product placed on the tray top surface in contact with the said first external surface of the multilayer film, and
a top film being sealed to top surface of the tray to form with the tray a hermetically sealed package; or
the vacuum package comprises
a tray, which is either a flat tray or a tray with a base wall and a side wall emerging from the base wall,
the product placed on a tray top surface in contact with the said first external surface of the first multilayer film, and
a top film formed by said multilayer film is sealed to the top surface of the tray to form with the tray a hermetically sealed package, with the first external surface of the multilayer film facing inside said package; or
the vacuum package comprises
a tray, which is either a flat tray or a tray with a base wall and a side wall emerging from the base wall, wherein the tray is formed by a first said multilayer film, with the first external surface of the first multilayer film forming the top surface of the tray receiving the product,
the product placed on the tray top surface in contact with the said first external surface of the first multilayer film, and
a top film formed by a second multilayer film sealed to the top surface of the tray to form with the tray a hermetically sealed package, with the first external surface of the second multilayer film facing inside said package.

21.-28. (canceled)
